(19) United States
(12) Patent Application Publication
(10) Pub. No.: US 2011/0013702 A1
(43) Pub. Date: Jan. 20, 2011

(54) DATA-RATE ADJUSTING DEVICE, DATA FEEDING SYSTEM, AND COMPUTER-READABLE MEDIUM

(75) Inventor: Shin FUJITA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/819,369

(22) Filed: Jun. 21, 2010

(30) Foreign Application Priority Data
Jul. 15, 2009 (JP) 2009-167058

(51) Int. Cl. H04N 11/02

(52) U.S. Cl. 375/240.26; 375/E07.026

(57) ABSTRACT

A data-rate adjusting device includes a first processing unit that adjusts a data rate for outputting an input data string by adding a bit string to the data string, the bit string being different from a predetermined bit string having a predetermined number of consecutive bits of an identical value and a second processing unit that outputs, to a data transmitting device, the data string to which the bit string is added.

### CROSS-REFERENCE TO RELATED APPLICATIONS

This application is based upon and claims the benefit of priority of the prior Japanese Patent Application No. 2009-167058, filed on Jul. 15, 2009, the entire contents of which are incorporated herein by reference.

### FIELD

Various embodiments described herein relate to a technology for transmitting a data string representing video, audio, and so on.

### BACKGROUND

One example of a stream-feed scheme for transmitting video data in real time via various communication means, such as Internet communication, is a scheme employing video encoding specified by the H.264 standard (ITU-T Rec. H.264|ISO/IEC 14496-10 AVC (Advanced Video Coding)) and data multiplexing using transport streams specified by the MPEG (Motion Picture Experts Group) 2 system standard (ISO/IEC 13818-1). Video-data real-time feed using the scheme is commonly available in digital television broadcast, Internet television broadcast, and so on.

Herein, the H.264 standard (ITU-T Rec. H.264|ISO/IEC 14496-10 AVC) is simply referred to as the “H.264 standard”. The MPEG-2 system standard (ISO/IEC 13818-1) is simply referred to as the “MPEG-2 system standard”. Herein, a transport stream may simply be referred to as a “TS”.

A typical demand in data feed is to feed video with highest possible image quality in the range of a band in which data can be transmitted through a data transmission channel. As an encoding system for such a usage environment, there is a scheme for feeding data over a network at a fixed rate (called a “CBR (constant bit rate))” in the entire system.

An example in which the H.264 standard and the MPEG-2 system standard are used to manage data in an image buffer unit, included in an encoding unit for encoding an image at a fixed coding rate, in order to perform real-time video-data feed at a CBR will now be described with reference to FIG. 1.

In FIG. 1, the horizontal axis indicates passage of time, and the vertical axis indicates the amount of encoded data stored in the image buffer unit, i.e., the amount of buffer data.

Each time the encoding unit completes image encoding, the encoded data is collectively stored in the image buffer unit. On the other hand, the encoded data is read at a certain rate according to a coding rate specified by the CBR. Thus, the amount of buffer data stored in the image buffer unit changes over time, as illustrated in FIG. 1.

When the amount of encoded data generated is small relative to the reading rate of the encoded data in the image buffer unit, the amount of buffer data decreases and is depleted eventually. Accordingly, when the amount of encoded data generated does not reach a predetermined amount, data that is unrelated to the encoded data, i.e., stuffed data, is stored in the image buffer unit in conjunction with the encoded data to thereby prevent depletion of the amount of buffer data.

As the stuffed data, filler data specified as nal_unit_type 12 in section 7.4.1 in the H.264 is used. Section 7.4.2.7 in the H.264 standard specifies that the value of the filler data is 0xff, that is, “11111111” in binary form.

Various schemes are available for communication between a feed source and a feed destination in data feed. One of such communication schemes is a PPP (point-to-point protocol) connection, which is a one-to-one-communication protocol typically used in wide area networks (WANs) and so on. Communication using the PPP connection is implemented based on High-level Data Link Control (HDLC) procedures, as described in RFC (Request For Comment) 1662 PPP in HDLC-like Framing.

The communication using the PPP connection enables efficient data transmission by using a bit stuffing function. The bit stuffing function will now be described.

In the HDLC procedures, a flag synchronization system is used for synchronization, so that data transmission can be continuously performed without waiting for an acknowledgement response from an apparatus at a data-receiving side, thereby increasing the speed of the data transmission.

FIG. 2 illustrates the structure of a data frame used for data transmission in the HDLC procedures.

As illustrated in FIG. 2, the data frame has a flag sequence, an address field, a control field, an information field, and a frame check sequence. The information field contains a data string to be transmitted. The flag sequence in the data frame will now be described.

The flag sequence is a data string provided at the beginning and the end of the data frame and is a bit string of “01111110” in binary form. Upon receiving the data frame from a data-transmitting-side apparatus, the data-receiving-side apparatus detects the flag sequence from the received data frame and performs data synchronization on the basis of the flag sequence.

In this case, however, when a bit string that is the same as the flag sequence exists in a data string other than the flag sequence in the data frame, the data-receiving-side apparatus falsely recognizes the bit string as a flag sequence. Accordingly, when a data string other than the flag sequence has five consecutive “1” bits, the data-transmitting side forcibly inserts a “0” bit next to the bit string, as in table 3001 in FIG. 3, to perform bit-string conversion. In turn, when a data string other than the flag sequence in the received data frame has five consecutive “1” bits, the data-receiving-side apparatus forcibly removes a “0” bit next to the bit string, as in table 3002 in FIG. 3, to perform bit-string inverse-conversion. The bit stuffing function is a function for converting a bit string that matches the flag sequence into another bit string, as described above, to construct a data frame so as to prevent the receiving-side apparatus to prevent false recognition of the flag sequence.

The bit stuffing function is used not only in the HDLC procedures but also in various transmission systems for transmitting digital data. For example, for a USB (universal serial bus) that employs NRZI (Non Return to Zero Inverted) as an information encoding system, when “1” bits continue in a transmission data string, the state of a transmission signal does not change and thus the synchronization between the transmitting side and the receiving side is shifted. Accordingly, when a predetermined number of “1” bits continue in a transmission data string, bit stuffing for inserting a “0” bit is performed to enable synchronization detection so as to suppress a shift in the synchronization between the transmitting side and the receiving side.

Another available technology is a technology in which during a process in which the amount of data remaining in the output buffer unit decreases gradually as a result of a difference between a video-signal coding rate and a transmission-line rate, a shortage in the amount of data remaining in the output buffer unit is replenished with null packets.

Still another available technology is a technology used for an apparatus for performing data communication by using a PIAFS (PHS Internet Access Forum Standard), which is a data communication protocol for a PHS (Personal Handy-phone System). In this technology, a portion contained in a PIAFS frame and filled with invalid data is stuffed with other transmission information.

A further available technology is a technology used for a data transmission apparatus for outputting packets at a predetermined rate. In this technology, packets having information regarding time at which the packets are to be output are generated. The data transmission apparatus has a timer for clocking the time at which the packets are to be output. The transmission apparatus sequentially outputs, at predetermined intervals of packets, packets that do not contain the time information, and outputs packets having the time information on the basis of the value of the timer.

The above-described technologies are discussed in, for example, Japanese Laid-open Patent Publication Nos. 11-298893, 2002-186031, and 2005-27006.

### SUMMARY

A data-rate adjusting device includes a first processing unit that adjusts a data rate for outputting an input data string by adding a bit string to the data string, the bit string being different from a predetermined bit string having a predetermined number of consecutive bits of an identical value and a second processing unit that outputs, to a data transmitting device, the data string to which the bit string is added.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of data control for an image buffer unit of related art;

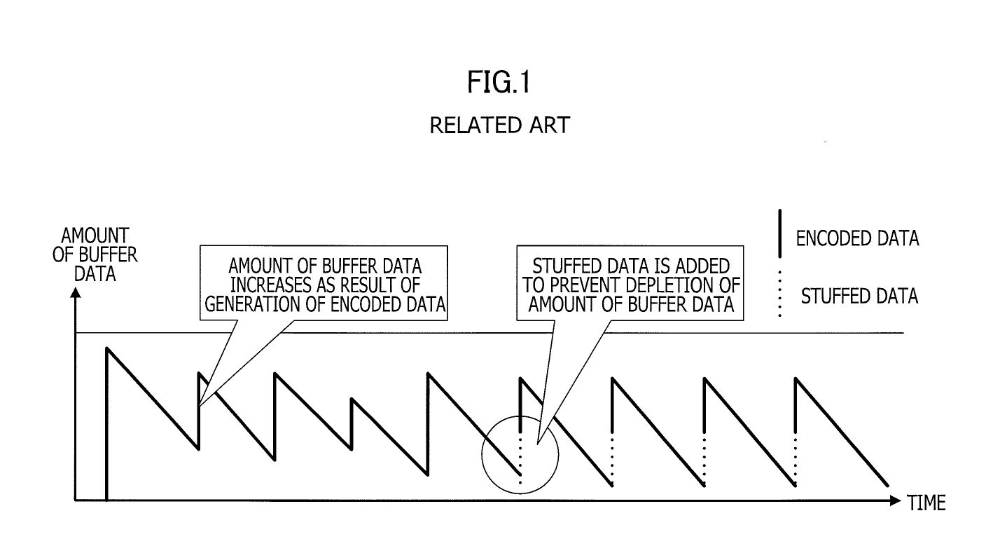

FIG. 2 is diagram illustrating the structure of a data frame, in the related art, used for data transmission in HDLC control procedures;

FIG. 3 illustrates a bit stuffing function in the related art;

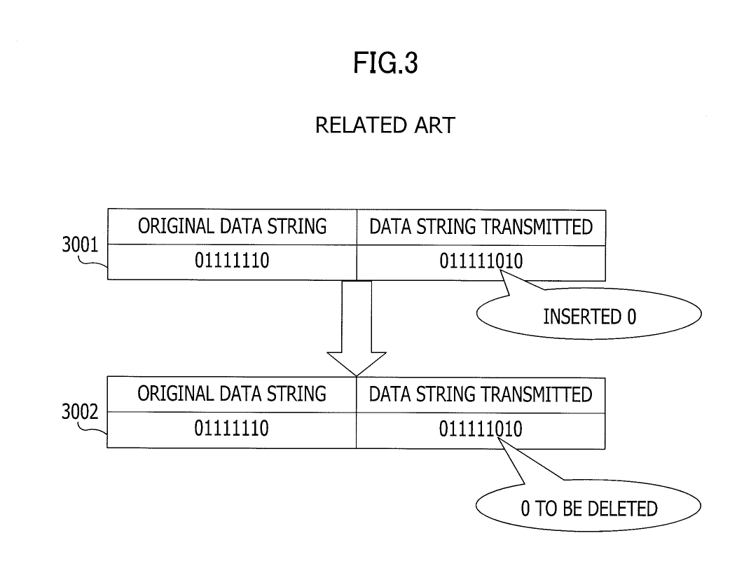

FIG. 4 is a schematic diagram illustrating a change in the amount of data of a data string in the related art;

FIG. 5 is a graph illustrating an increase in the amount of data to be transmitted, the increase being caused by the bit stuffing function in the related art;

FIG. 6 is a block diagram of an entire image-data transmission system;

FIG. 7 is a block diagram of an image encoding device;

FIG. 8 is a block diagram of a feeding-side modem;

FIG. 9 is a flow diagram illustrating a processing sequence of elements in the image encoding device;

FIG. 10 is a flow diagram illustrating a processing sequence of elements in the feeding-side modem;

FIG. 11A is a block diagram of a first example of the configuration of an encoding unit;

FIG. 11B is a block diagram of a first example of the configuration of a multiplexing unit;

FIG. 12A is a schematic flow diagram illustrating a processing sequence of elements in the encoding unit having the configuration illustrated in FIG. 11A;

FIG. 12B is a schematic flow diagram illustrating a processing sequence of elements in the multiplexing unit having the configuration illustrated in FIG. 11B;

FIG. 13 is a block diagram illustrating an advantage of data-feed-rate adjustment performed by a null TS creating unit;

FIG. 14 is a block diagram illustrating a typical example of the configuration of a computer;

FIG. 15 is a flowchart illustrating details of null-TS creation processing;

FIG. 16A is a block diagram of a second example of the configuration of the encoding unit;

FIG. 16B is a block diagram of a second example of the configuration of the multiplexing unit;

FIG. 17A is a schematic flow diagram illustrating a processing sequence of elements in the encoding unit having the configuration illustrated in FIG. 16A;

FIG. 17B is a schematic flow diagram illustrating a processing sequence of elements in the multiplexing unit having the configuration illustrated in FIG. 16B;

FIG. 18 is a block diagram illustrating an advantage of data-feed-rate adjustment performed by a SEI NAL creating unit;

FIG. 19 is a flowchart illustrating processing descriptions of SEI NAL creation processing;

FIG. 20 is a block diagram of a second example of the configuration of the encoding unit;

FIG. 21 is a schematic flow diagram illustrating a processing sequence of elements in the encoding unit having the configuration illustrated in FIG. 20;

FIG. 22 is a block diagram illustrating an advantage of data-feed-rate adjustment performed by an unspecified-NAL creating unit; and

FIG. 23 is a flowchart illustrating processing descriptions of unspecified-NAL creation processing.

### DESCRIPTION OF EMBODIMENTS

When a transmission system utilizing a bit stuffing function is used for feeding video data in real time at the above-described CBR, there are cases in which video cannot be properly played back at the feed destination. This phenomenon will now be described.

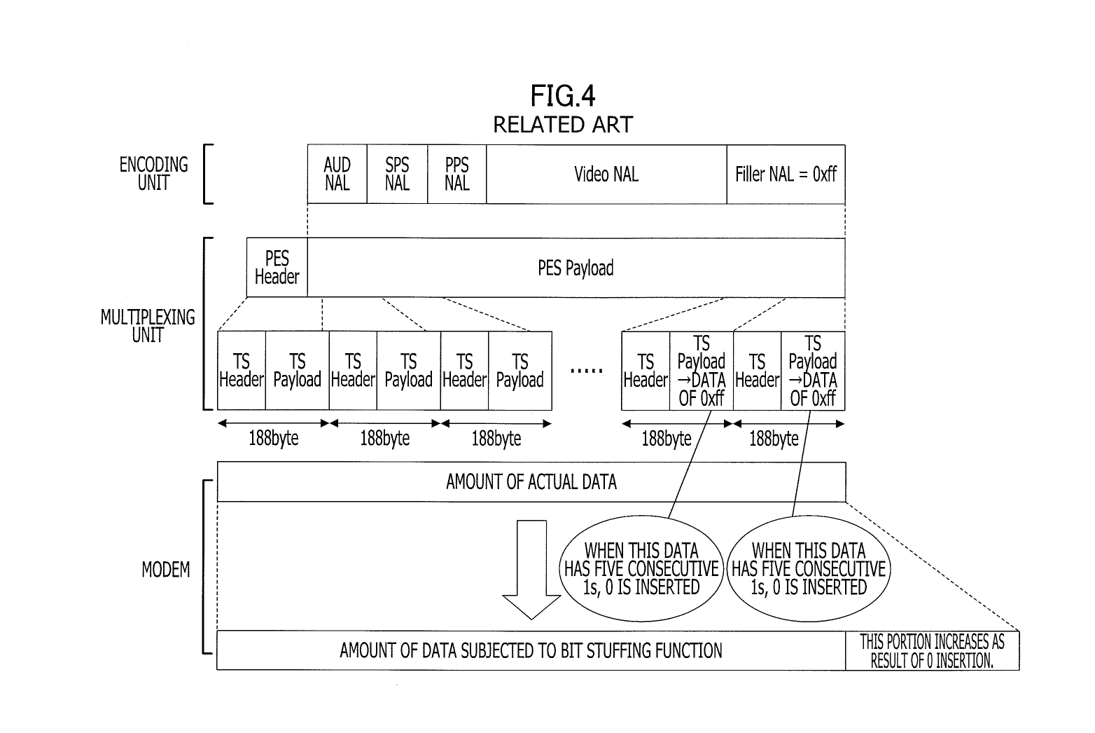

FIG. 4 schematically illustrates a change in the amount of data of a data string in the related art.

An encoding unit performs video encoding specified by an H.264 standard and output NALs (network abstraction layers) at the CBR. The term “NAL unit” refers to a data string obtained by encapsulating encoded data, a parameter set, or the like needed to decode the encoded data. FIG. 4 illustrates an AUD (access unit delimiter) NAL unit, an SPS (sequence parameter set) NAL unit, a PPS (picture parameter set) NAL unit, a video NAL unit, and a filler NAL unit. The filler NAL unit contains the above-described filler data, which is filled with values of 0xff.

A multiplexing unit performs multiplexing using predetermined TSs (transport streams) specified by an MPEG-2 system standard. The multiplexing unit first multiplexes an access unit, which is one group of NAL units output from the encoding unit, into a PES (packetized elementary stream) packet. The PES packet has a data structure in which predetermined header information (PES header) is added to PES payload that contains the access unit output from the encoding unit. The multiplexing unit multiplexes the PES packet into TS packets each having 188 bytes. Each TS packet has a data structure in which predetermined header information (TS header) is added to TS payload that contains one of divided data series of the PES packet. Thus, the TS payload in the TS packet containing the above-mentioned filler-NAL-containing portion in the PES packet is also filled with filler data having values of 0xff.

The TS packets are output from the multiplexing unit and are transmitted to a communication network, such as a WAN (wide area network), via a modem. When the modem employs a flag synchronization system based on the HDLC procedures, the modem executes the above-described bit stuffing, which forcibly inserts a “0” bit next to a data series of five consecutive “1” bits, on the TS packets. In this case, since the TS payload in the TS packet containing the above-described filler-NAL-containing portion in the PES packet is also filled with filler data having values of 0xff, “0” bit insertion by the bit stuffing is performed a large number of times. As a result, the amount of data transmitted from the modem to the communications network increases significantly compared to the amount of data of the TS packets output from the multiplexing unit.

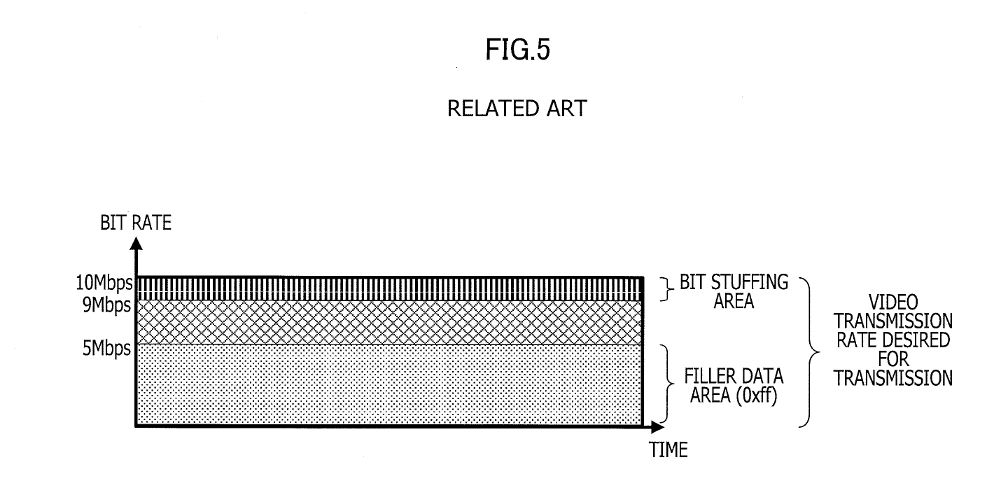

Such an increase in the amount of transmission data, the increase being caused by the bit stuffing function, will further be described with reference to FIG. 5.

In FIG. 5, the horizontal axis indicates passage of time and the vertical axis indicates a bit rate, which is the amount of data per unit time.

In the example of FIG. 5, 9 Mbps is set as the CBR. FIG. 5 illustrates a case in which the encoding unit inserts, at a rate of 5 Mbps, filler data into generated 4 Mbps encoded data. In this case, in the above-described bit stuffing, “0” data is inserted at a rate of 1 Mbps (=5 Mbps×⅕). In this case, bit stuffing for header information and so on is disregarded. Thus, in this case, the amount of data transmitted from the modem to the communications network is given by:

4 Mbps+5 Mbps+1 Mbps=10 Mbps.

Thus, in this case, when the allowable transmission rate in the communications network is 10 Mbps, video data can be properly fed to a feed destination and thus video can be properly played back.

Next, a case in which video of a color bar still image is encoded will now be discussed by way of example. With such video, since the amount of encoded data generated by the encoding unit is reduced, the encoding unit inserts a larger amount of filler data than the amount of filler data in the case described above. For example, it is assumed in this case that 9 Mbps is set as the CBR, as in case described above, and the encoding unit inserts filler data into generated 2 Mbps encoded data at a rate of 7 Mbps. In this case, in the above-described bit stuffing, “0” data is inserted at a rate of 1.4 Mbps (=7 Mbps×⅕). Thus, in this case, the amount of data transmitted from the modem to the communications network is given by:

2 Mbps+7 Mbps+1.4 Mbps=10.4 Mbps.

Thus, in this case, when the allowable transmission rate in the communications network is 10 Mbps, not all video data can be properly fed to the feed destination and thus the video cannot be properly played back.

Embodiments will be described below with reference to the accompanying drawings. Embodiments described below can be appropriately combined within the scope in which no contradiction occurs in processing described below.

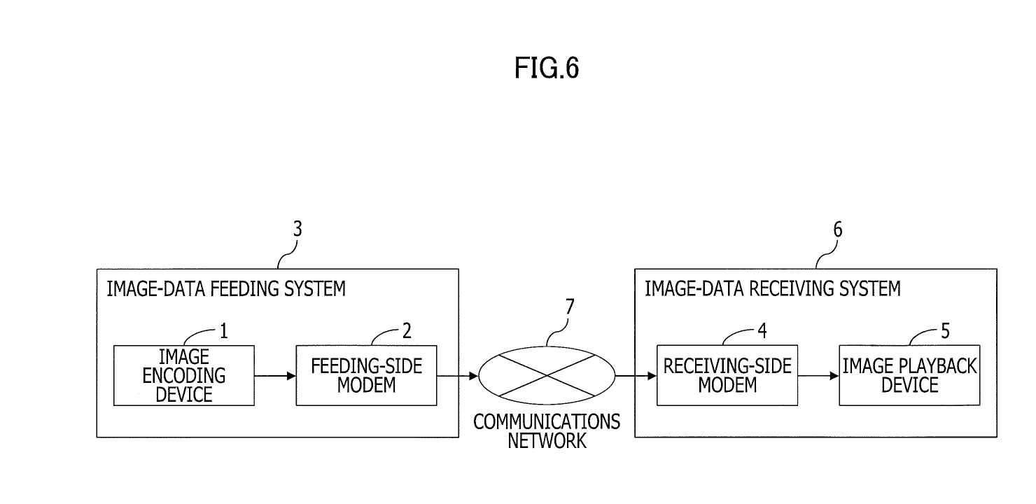

FIG. 6 illustrates an overall configuration of an image-data transmission system. The image-data transmission system performs stream feeding for transmitting video data in real time.

In FIG. 6, an image encoding device 1 and a feeding-side modem 2 constitute an image-data feeding system 3, and a receiving-side modem 4 and an image playback device 5 constitute an image-data receiving system 6.

The image-data feeding system 3 performs video encoding on a video signal output from a video camera or the like and transmits the resulting encoded data to a communications network 7. On the other hand, the image-data receiving system 6 receives the encoded data, transmitted from the image-data feeding system 3, and displays resulting video.

The image encoding device 1 performs video encoding, specified by the H.264 standard, on an input video signal and performs data multiplexing using TSs specified by the MPEG-2 system standard.

The feeding-side modem 2 serves as a data transmitting device. The feeding-side modem 2 performs PPP-connection-based communication with the receiving-side modem 4 in the image-data receiving system 6 through the communications network 7 to transmit a multiplexed video data string, output from the image encoding device 1, to the receiving-side modem 4.

The receiving-side modem 4 receives the multiplexed video data string transmitted from the feeding-side modem 2 in the image-data feeding system 3 and outputs the received multiplexed video data string to the image playback device 5.

The image playback device 5 decodes the multiplexed video data string, received from the receiving-side modem 4, in accordance with the video encoding system and the data multiplexing system of the image encoding device 1 to reproduce the video signal input to the image encoding device 1. The image playback device 5 then causes video, represented by the video signal, to be displayed on a display device.

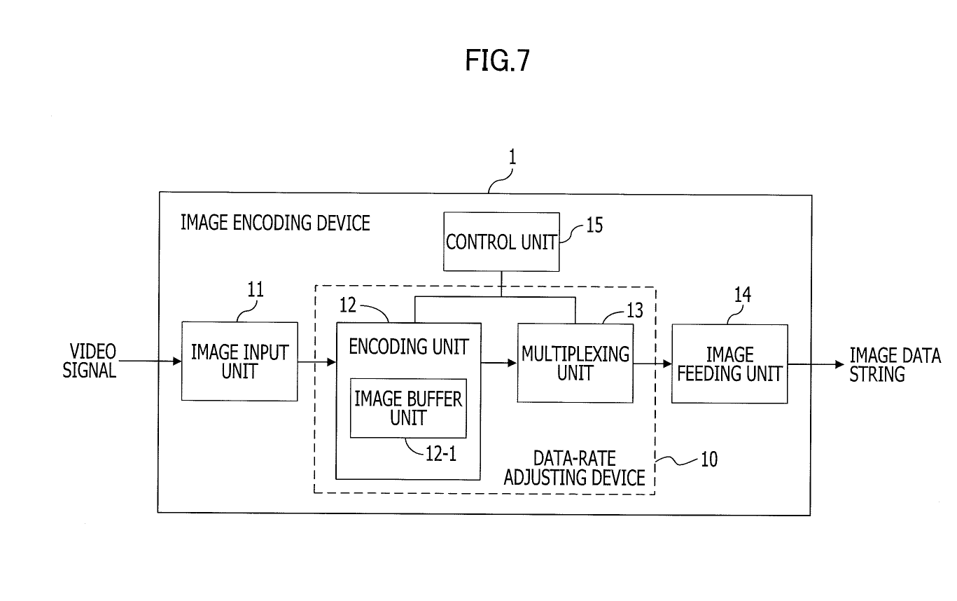

FIG. 7 illustrates the configuration of the image encoding device 1.

The image encoding device 1 includes an image input unit 11, an encoding unit 12, a multiplexing unit 13, an image feeding unit 14, and a control unit 15.

The image input unit 11 receives a video signal output from an external apparatus (such as a video camera) and input to the image encoding device 1.

The encoding unit 12 performs video encoding, specified by the H.264 standard, on the video signal received by the image input unit 11, in accordance with a coding rate pre-specified by the control unit 15. Image data obtained by the video encoding is stored in an image buffer unit 12-1, which is a FIFO (first-in first-out) memory provided in the encoding unit 12.

The multiplexing unit 13 reads image data, stored in the image buffer unit 12-1, at a predetermined rate, multiplexes the read image data by using TSs specified by the MPEG-2 system standard, and outputs an image data string (TS packets).

The image feeding unit 14 outputs the image data string (TS packets), output from the multiplexing unit 13, to the feeding-side modem 2.

The encoding unit 12 or the multiplexing unit 13 of the elements in the image encoding device 1 also operates as a data-rate adjusting device 10 for adjusting the data feed rate at which the image-data feeding system 3 feeds the video data string. This operation is described below.

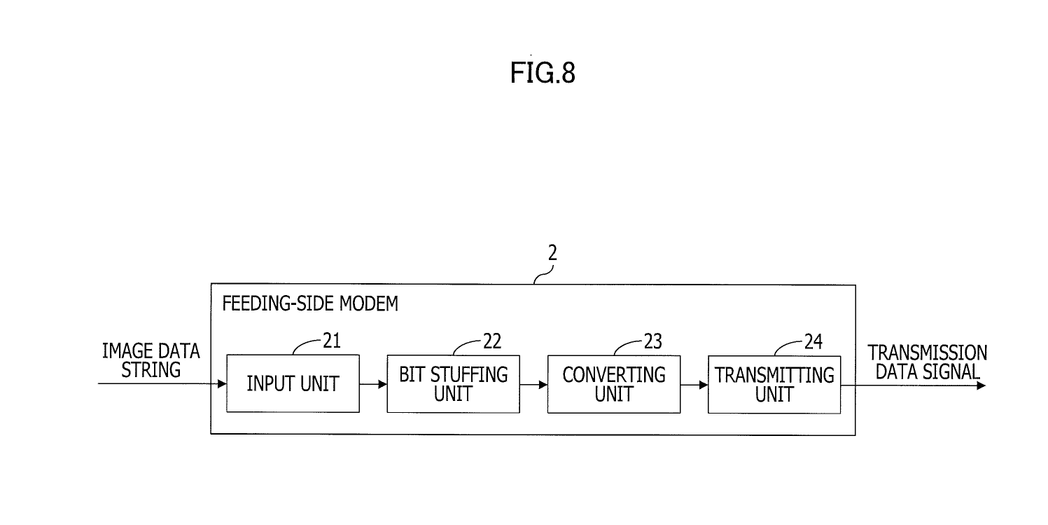

FIG. 8 illustrates the configuration of the feeding-side modem 2, which serves as a data transmitting device. The feeding-side modem 2 includes an input unit 21, a bit stuffing unit 22, a converting unit 23, and a transmitting unit 24.

The input unit 21 receives a video data string output from the image encoding device 1 and input to the feeding-side modem 2.

The bit stuffing unit 22 performs bit stuffing processing on the video data string received by the input unit 21. That is, the bit stuffing unit 22 detects a portion having a predetermined number of consecutive “1” bits from the video data string. In the present embodiment, the predetermined number of bits is five. In the present embodiment, a portion having the predetermined number of consecutive “1” bits is referred to as a “predetermined bit string”. When the predetermined bit string is contained in a video data string, a “0” bit, i.e., a bit having a value that is different from a “1” bit, is inserted next to the predetermined bit string in the video data string.

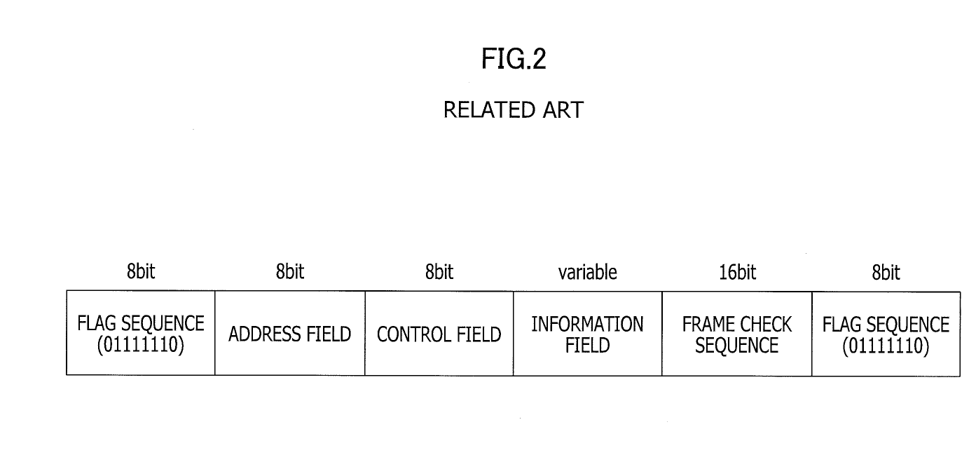

The converting unit 23 converts the format of the video data string after the bit stuffing processing is performed. That is, the converting unit 23 stores the video data string in the information field of the data frame illustrated in FIG. 2 and also adds a flag sequence, an address field, a control field, and a frame check sequence to the resulting data to thereby create the data frame illustrated in FIG. 2. In the present embodiment, a flag sequence for use in the data string transmission in the flag synchronization control between the feeding-side modem 2 and the receiving-side modem 4 is a bit string “01111110” in binary form, as illustrated in FIG. 2.

The transmitting unit 24 addresses the video data string, format-converted by the converting unit 23, to the image-data receiving system 6 and transmits the video data string to the communications network 7.

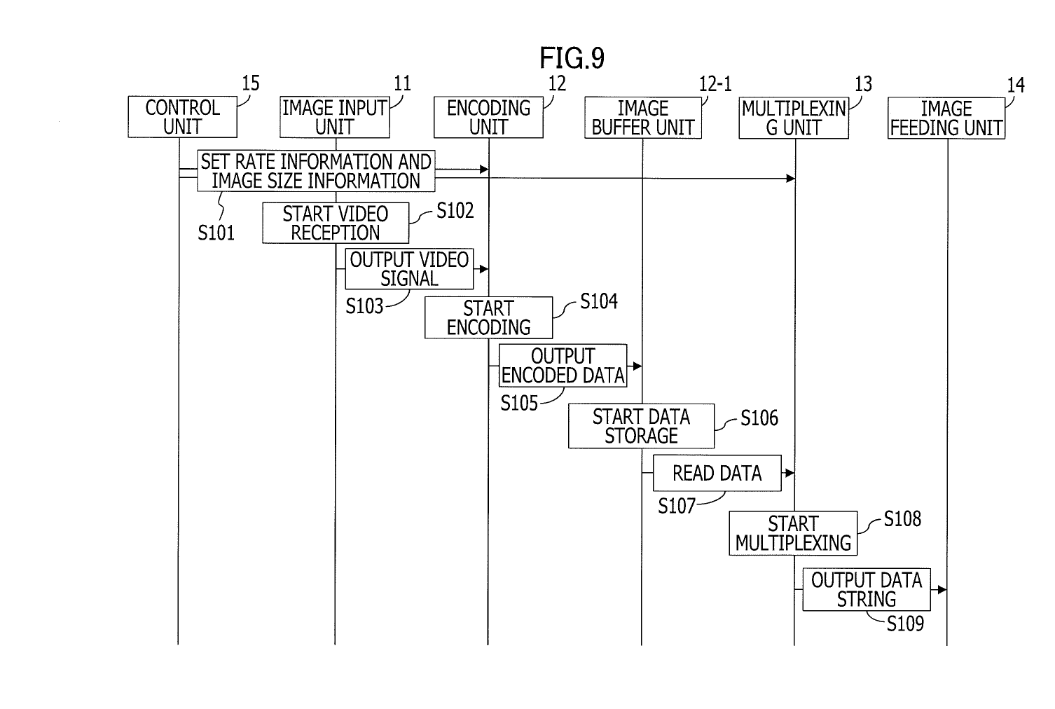

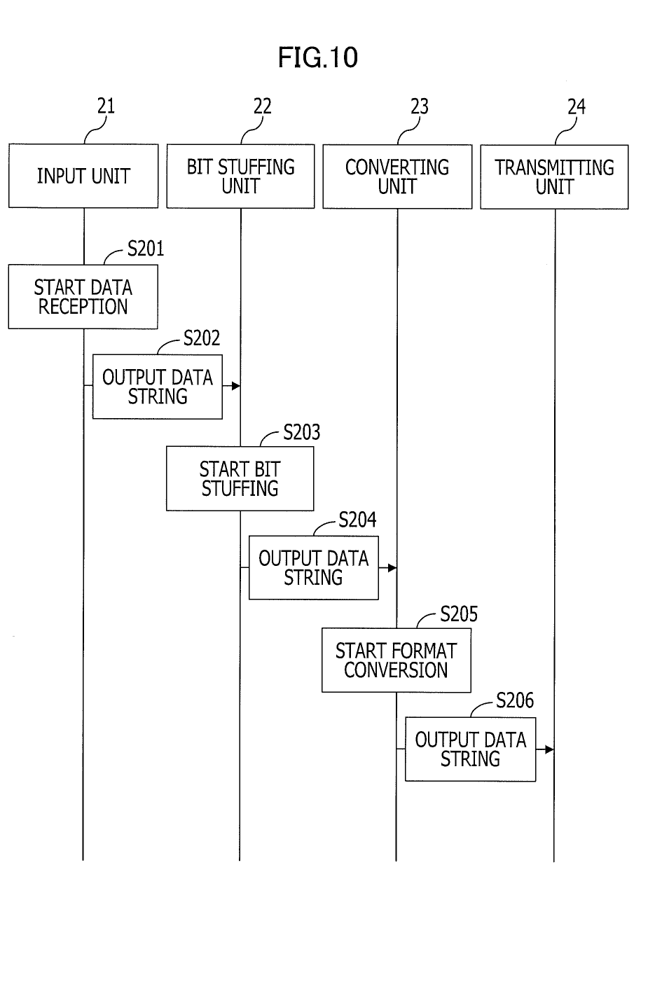

The operation of the image-data feeding system 3 will now be described with reference to FIGS. 9 and 10. FIG. 9 illustrates a processing sequence for the elements in the image encoding device 1 and FIG. 10 illustrates a processing sequence for the elements in the feeding-side modem 2.

Referring to FIG. 9, first, in step S101, the control unit 15 performs an operation for reporting image size information and an encoding bit rate to the encoding unit 12 and the multiplexing unit 13. The encoding unit 12 and the multiplexing unit 13 perform corresponding operations in accordance with the image size information and the encoding bit rate reported from the control unit 15.

When a video signal transmitted from the external apparatus is input to the image encoding device 1, the image input unit 11 starts an operation for receiving the video signal in step S102. Subsequently, in step S103, the image input unit 11 passes the received video signal to the encoding unit 12.

Upon receiving the video signal from the image input unit 11, the encoding unit 12 starts an operation for video encoding processing, specified by the H.264 standard, on the video signal in step S104. The video encoding processing is performed according to the image size information and the encoding bit rate reported from the control unit 15. Next, in step S105, the encoding unit 12 passes the encoded image data, obtained by the video encoding processing, to the image buffer unit 12-1.

Upon receiving the encoded image data from the encoding unit 12, the image buffer unit 12-1 starts an operation for storing the encoded image data in step S106.

When the amount of encoded image data stored in the image buffer unit 12-1 exceeds a predetermined amount, the multiplexing unit 13 performs an operation in step S107 for reading the encoded image data stored in the image buffer unit 12-1. In step S108, the multiplexing unit 13 starts an operation for multiplexing processing using TSs, specified by the MPEG-2 system standard, to obtain an image data string, which is multiplexed encoded image data. Next, in step S109, the multiplexing unit 13 passes the image data string to the image feeding unit 14, so that the image data string is output from the image encoding device 1.

Referring now to FIG. 10, when the image data string is input from the image encoding device 1 to the feeding-side modem 2, the input unit 21 starts an operation for receiving the image data string in step S201. Subsequently, in step S202, the input unit 21 passes the received image data string to the bit stuffing unit 22.

Upon receiving the image data string from the input unit 21, the bit stuffing unit 22 starts the above-described bit stuffing processing operation on the image data string in step S203. Subsequently, in step S204, the bit stuffing unit 22 passes the image data string, subjected to the bit stuffing processing, to the converting unit 23.

Upon receiving the bit-stuffed image data string from the bit stuffing unit 22, the converting unit 23 starts the above-described format-conversion operation on the image data string in step S205. Subsequently, in step S206, the converting unit 23 passes the format-converted image data string to the transmitting unit 24, so that the transmitting unit 24 transmits the image data string, addressed to the image-data receiving system 6, to the communications network 7.

Next, a description will be given of detailed configurations of the encoding unit 12 and the multiplexing unit 13 and some embodiments of a scheme for an operation, performed thereby, for adjusting the data feed rate in the video-data string feed.

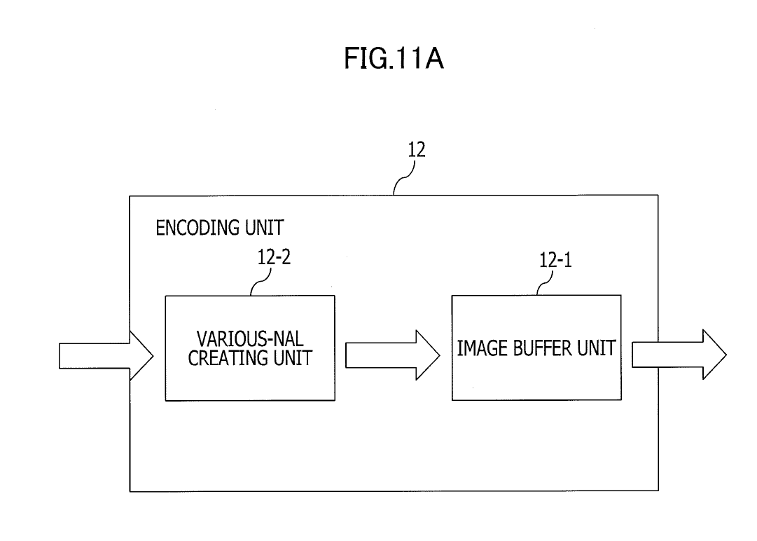

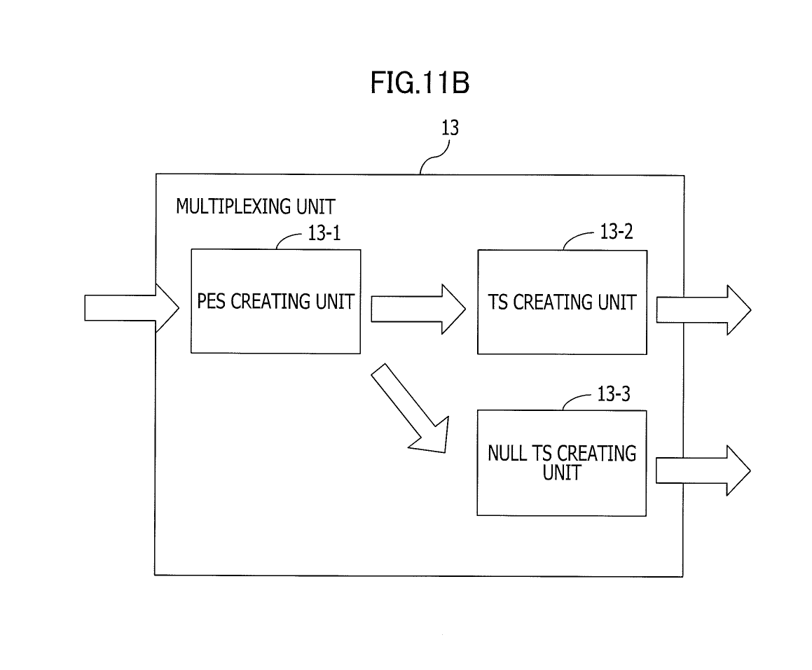

First, a description will be given with reference to FIGS. 11A and 11B. FIGS. 11A and 11B illustrate first examples of the configurations of the encoding unit 12 and the multiplexing unit 13, respectively.

The encoding unit 12 illustrated in FIG. 11A includes the above-described image buffer unit 12-1 and a NAL creating unit 12-2 for creating AUD, SPS, PPS, and video NALs. This NAL creating unit 12-2 is hereinafter referred to as a “various-NAL creating unit”.

The various-NAL creating unit 12-2 performs video encoding, specified by the H.264 standard, on the video signal received by the image input unit 11 and encapsulates the encoded image data to create various NAL units in accordance with the type of data.

More specifically, the various-NAL creating unit 12-2 encapsulates the image data into AUD, SPS, PPS, and video NAL units specified by the H.264 standard. The AUD NAL contains information indicating the beginning of an access unit, which is one group of various NAL units created by the various-NAL creating unit 12-2. The SPS NAL stores various types of information regarding encoding of the entire image sequence, which is one group containing encoded data in one access unit and including multiple images constituting a moving image. The PPS NAL contains various types of information regarding encoding of pictures, which are images constituting a moving image. The video NAL contains raw encoded data of each picture, the raw encoded data being generated by the image encoding.

The various-NAL creating unit 12-2 outputs the image data encapsulated into the various NAL units in the manner described above, that is, the image data that is a collection of NAL units containing the encoded video data, to the image buffer unit 12-1. The image buffer unit 12-1 stores the image data.

On the other hand, the configuration of the multiplexing unit 13 illustrated in FIG. 11B corresponds to a case in which the encoding unit 12 has the configuration illustrated in FIG. 11A, and includes a PES creating unit 13-1, a TS creating unit 13-2, and a null TS creating unit 13-3.

The PES creating unit 13-1 creates a PES packet containing the image data stored in the encoding unit 12-1, the PES packet being specified by the MPEG-2 system standard. More specifically, the PES creating unit 13-1 stores the image data in the PES payload for each access unit described above and adds a PES header, which has predetermined header information, to the resulting payload to create a PES packet. The above-described image data is particularly referred to as “ES (elementary stream) data”.

The TS creating unit 13-2 creates TS packets containing the PES packet created by the PES creating unit 13-1, the TS packets being specified by the MPEG-2 system standard. More specifically, the TS creating unit 13-2 stores data strings, obtained by dividing the PES packet, in TS payload, and adds a TS header, which has predetermined header information, to the TS payload to thereby create a group of TS packets, each having an amount of data of 188 bytes.

The null TS creating unit 13-3 creates a TS packet (specified by the MPEG-2 system standard) having 188-byte data and having TS payload containing a bit string other than the above-described predetermined bit string. In particular, in the present embodiment, the bit string that the null TS creating unit 13-3 stores in the TS payload does not contain the above-described predetermined bit string and is, for example, repetitions of 0x55, that is, “01010101” in binary form. In the present embodiment, the predetermined bit string is “11111” in binary form.

An example of the bit string is not limited to 0x55 and may be, for example, 0xAA, i.e., “10101010” in binary form. That is, the bit string may be any bit string that does not contain the bit string (in the present embodiment, “11111” in binary form) to be subjected to the bit stuffing processing. With this arrangement, even when the bit stuffing unit 22 in the feeding-side modem 2 performs the bit stuffing processing, a “0” bit is not inserted into that bit string to thereby suppress an increase in the amount of transmission data, the increase resulting from the bit stuffing.

In this case, the null TS creating unit 13-3 sets a packet ID to a null packet, the packet ID being contained in the TS header in the TS packet created and being indicative of the type of data stored in the payload of the TS packet. Section 2.4.3.3 in the MPEG-2 system standard defines that the packet ID indicating a null packet is 0x1fff. According to the standard, any data can be contained in the payload of a TS packet that is a null packet, which is ignored during decoding of the encoded data. Thus, a TS packet having payload that contains a bit string as described above has almost no influence on image playback performed by the image-data receiving system 6. A TS packet that is a null packet is hereinafter referred to as a “null TS packet”.

For example, the null TS creating unit 13-3 adds null TS packet(s), created thereby, to the end of the TS packet group created by the TS creating unit 13-2, and outputs the resulting packets to the image feeding unit 14.

The null TS creating unit 13-3 also adjusts the amount of null TS packets to be created. This adjustment is performed so that the sum of the amount of null TS packets to be created by the null TS creating unit 13-3 and the amount of TS packets created by the TS creating unit 13-2 corresponds to the feed rate of the image data string transmitted from the image-data feeding system 3 to the image-data receiving system 6. The above-described encoding bit rate that the control unit 15 reports to the multiplexing unit 13 is assumed to represent that feed rate. On the basis of the reported feed rate and the amount of null TS packets to be created, the null TS creating unit 13-3 adjusts the amount of null TS packets to be created. As described above, the null TS creating unit 13-3 adjusts the data feed rate for feeding the image data string from the image-data feeding system 3 to the image-data receiving system 6.

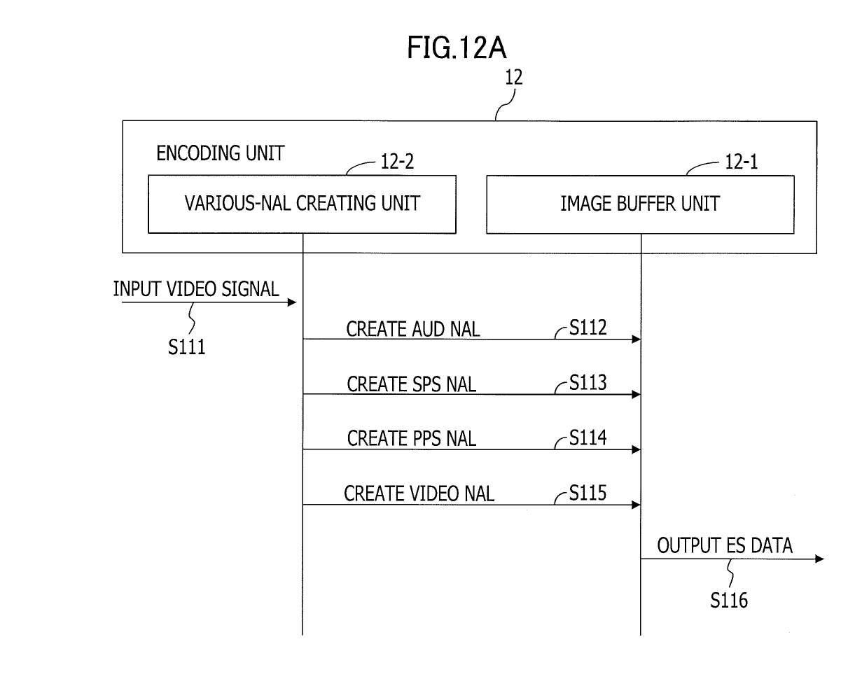

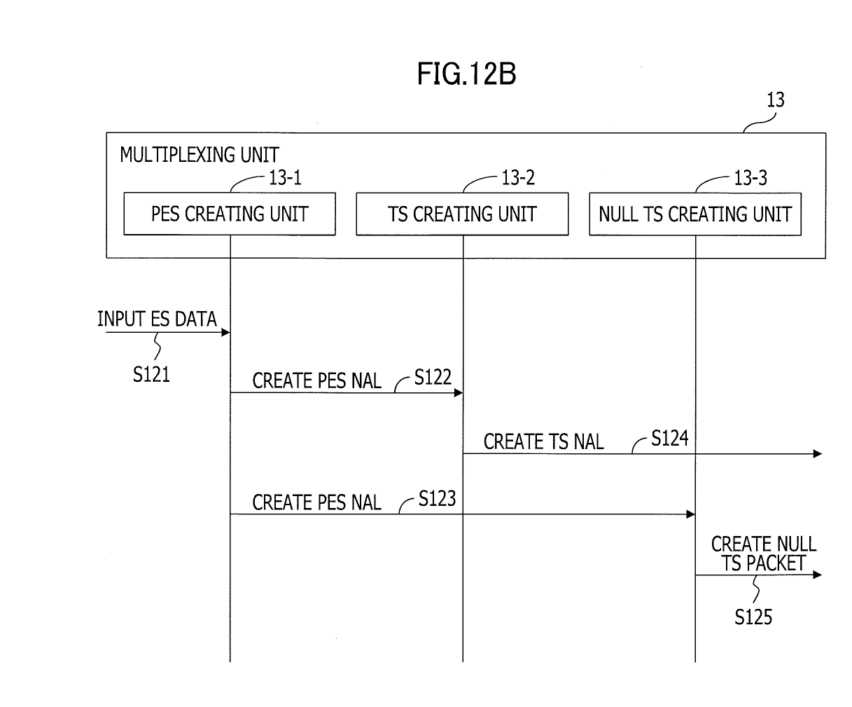

The operations of the encoding unit 12 having the configuration illustrated in FIG. 11A and the multiplexing unit 13 having the configuration illustrated in FIG. 11B will now be described with reference to FIGS. 12A and 12B. FIG. 12A illustrates a processing sequence for the elements in the encoding unit 12 having the configuration illustrated in FIG. 11A and FIG. 12B illustrates a processing sequence for the elements in the multiplexing unit 13 having the configuration illustrated in FIG. 11B.

In step S103 described above and illustrated in FIG. 9, the received video signal is passed from the image input unit 11 to the encoding unit 12. In step S111 in FIG. 12A, the various-NAL creating unit 12-2 receives the input video signal and performs processing for creating various NAL units from the video signal and storing the NAL units in the image buffer unit 12-1. More specifically, in step S112, the various-NAL creating unit 12-2 performs processing for creating an AUD NAL and storing the AUD NAL in the image buffer unit 12-1. In step S113, the various-NAL creating unit 12-2 performs processing for creating an SPS NAL and storing the SPS NAL in the image buffer unit 12-1. Next, in step S114, the various-NAL creating unit 12-2 performs processing for creating a PPS NAL and storing the PPS NAL in the image buffer unit 12-1. Subsequently, in step S115, the various-NAL creating unit 12-2 performs processing for creating a video NAL and storing the video NAL in the image buffer unit 12-1.

In step S116, the various NAL units stored in the image buffer unit 12-1, as described above, are sequentially read by and output to the multiplexing unit 13 as ES data.

Next, upon input of the ES data in step S121 in FIG. 12B, the PES creating unit 13-1 performs processing for crating a PES packet from the ES data and outputting the PES packet to the TS creating unit 13-2 in step S122. In step S123, the PES creating unit 13-1 also performs processing for outputting the PES packet, created by the processing in step S122, to the null TS creating unit 13-3.

Upon receiving the PES packet from the PES creating unit 13-1, in step S124, the TS creating unit 13-2 performs processing for creating a TS packet group containing the PES packet. On the other hand, upon receiving the PES packet from the PES creating unit 13-1, in step S125, the null TS creating unit 13-3 performs processing for creating null TS packet(s) and outputting the null TS packet(s) together with the TS packet group. In this case, the null TS creating unit 13-3 first determines the amount of TS packets to be created by the TS creating unit 13-2, on the basis of the received PES packet. By subtracting the determined amount from the amount of transmission data corresponding to the aforementioned feed rate reported from the control unit 15, the null TS creating unit 13-3 determines the amount of null TS packets to be created.

Utilization of the fact that the TS packet has a fixed length of 188 bytes and the TS header has a fixed length of 4 bytes facilitates that the amount of TS packets created by the TS creating unit 13-2 is determined on the basis of the amount of data of the PES packet. Instead of the determination method, a table indicating relationships between the amount of data of the PES packet and the amount of TS packets to be created by the TS creating unit 13-2 may be prepared so that the amount of TS packets to be created can be determined from the amount of data of the received PES packet based on the table.

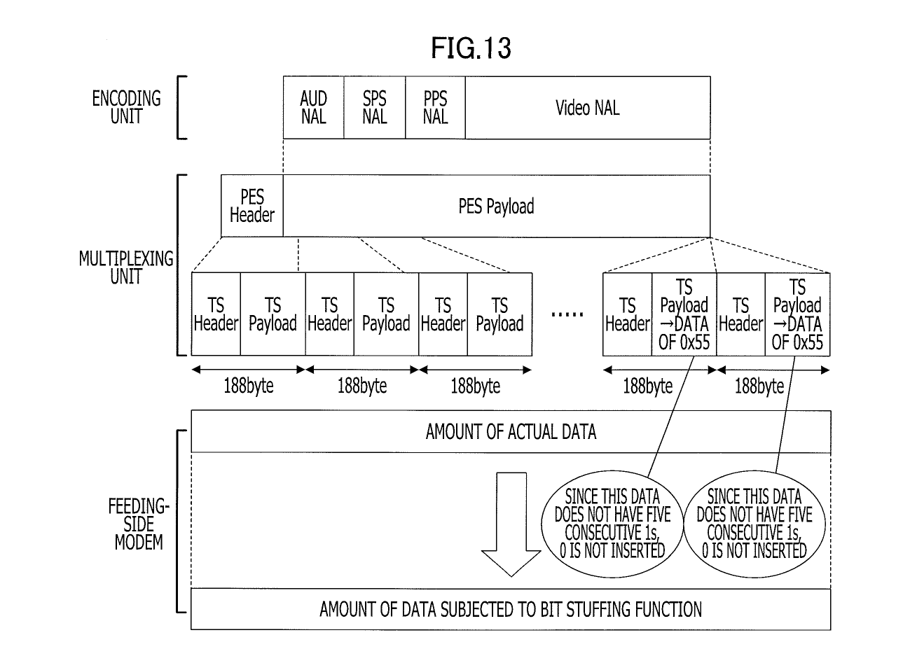

FIG. 13 schematically illustrates a change in the amount of data of the data string output from the units in the image-data feeding system 3 including the image encoding device 1 when the encoding unit 12 and the multiplexing unit 13 have the respective configurations illustrated in FIG. 11A and FIG. 11B. An advantage of the data-feed-rate adjustment performed by the null TS creating unit 13-3 will now be described with reference to FIG. 13 in comparison with FIG. 4.

As described above, in FIG. 4, in order to adjust the data feed rate, the above-described filler data is stored in the image buffer unit 12-1 in conjunction with the encoded data. Thus, the TS payload in the TS packet containing the above-mentioned filler-NAL-containing portion in the PES packet is filled with filler data having values of 0xff. Consequently, the “0” bit insertion by the bit stuffing is performed a large number of times, and thus the amount of data transmitted from the modem increases significantly compared to the amount of data of the TS packets output from the multiplexing unit.

On the other hand, when the amount of null TS packets to be created by the null TS creating unit 13-3 is adjusted to adjust the data feed rate, “0” bit insertion by the bit stuffing is not performed, since the predetermined bit string does not exist in the payload in the null TS packet. Thus, as illustrated in FIG. 13, this arrangement suppresses an increase in the amount of data transmitted from the feeding-side modem 2 relative to the amount of data of the TS packets including the null TS packet(s) output from the multiplexing unit 13.

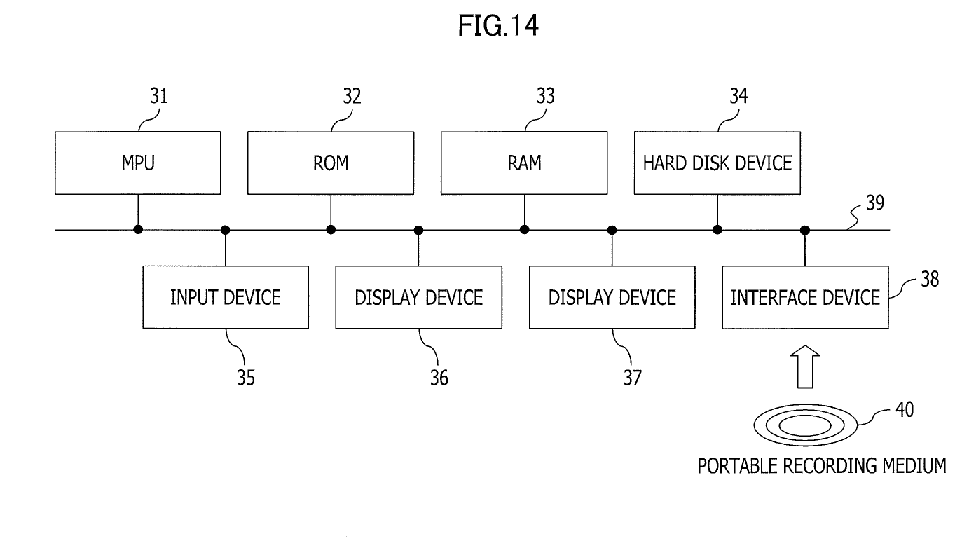

FIG. 14 illustrates an example of a typical configuration of a computer. Causing such a computer to execute a predetermined control program also allows the computer to implement the null TS creating unit 13-3 illustrated in FIG. 11B.

The computer illustrated in FIG. 14 includes an MPU (micro processing unit) 31, a ROM (read only memory) 32, a RAM (random access memory) 33, a hard disk device 34, an input device 35, a display device 36, an interface device 37, and a recording-medium drive device 38. These elements are all coupled to a bus 39 and are capable of exchanging various types of data with each other under the control of the MPU 31.

The MPU 31 is a computation processing device for controlling the entire operation of the computer.

The ROM 32 is a read only semiconductor memory in which a predetermined basic control program is pre-recorded. By reading and executing the basic control program upon start of the computer, the MPU 31 can control the operation of the elements in the computer.

The RAM 33 is a randomly readable/writable semiconductor memory and is used as a storage area for work, as needed, when the MPU 31 executes various control programs.

The hard disk device 34 is a storage device that stores various control programs executed by the MPU 31, various data tables (described below), and various types of image data. The MPU 31 reads a predetermined control program stored in the hard disk device 34 and executes the predetermined control program to thereby enable various types of control processing described below.

The input device 35 may be implemented by, for example, a keyboard device and a mouse device. When the user of the computer operates the input device 35, it obtains information input by the user and associated with the user operation and sends the obtained input information to the MPU 31.

The display device 36 is, for example, a liquid crystal display and displays various types of text and images in accordance with display data sent from the MPU 31.

The interface device 37 controls exchange of various types of data between other elements in the multiplexing unit 13 and the elements in the image encoding device 1.

The recording-medium drive device 38 reads various control programs or data recorded on a portable recording medium 40. The MPU 31 can also perform various types of control processing (described below) by reading a predetermined control program, stored on the portable recording medium 40, via the recording-medium drive device 38 and executing the read predetermined control program. Examples of the portable recording medium 40 include a CD-ROM (Compact Disc Read Only Memory) and a DVD-ROM (Digital Versatile Disc Read Only Memory).

When such a computer is used to realize the null TS creating unit 13-3, a control program for causing the MPU 31 to perform null-TS creation processing described below is created first. The created control program is pre-stored in the hard disk device 34 or on the portable recording medium 40. A predetermined instruction is then given to the MPU 31 to cause it to read and execute the control program. With this arrangement, the MPU 31 in the computer illustrated in FIG. 14 serves as the null TS creating unit 13-3.

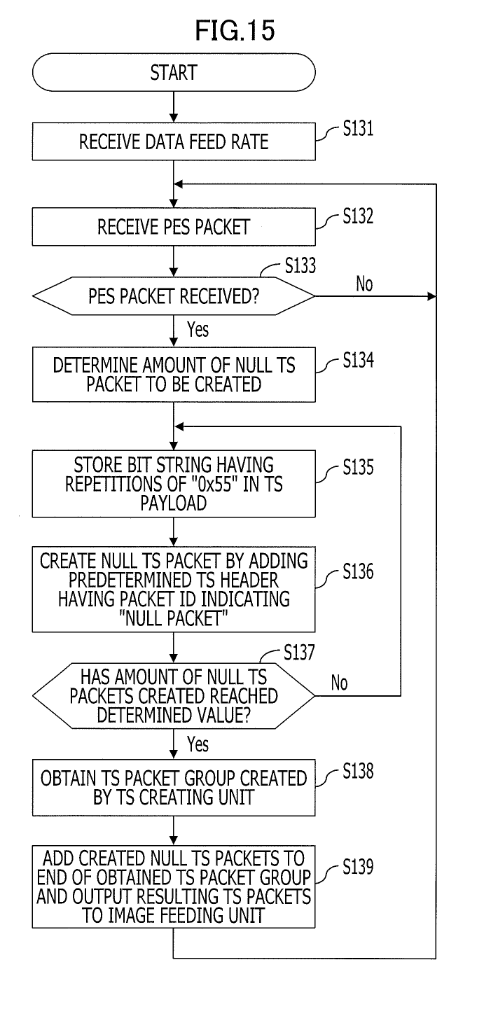

FIG. 15 is a flowchart illustrating the details of the null-TS creation processing that is to be performed by the MPU 31 so as to cause the computer to serve as the null TS creating unit 13-3.

Upon start of the processing in FIG. 15, first, in step S131, the MPU 31 performs processing for receiving the encoding bit rate, i.e., the aforementioned feed rate, reported from the control unit 15.

Next, in step S132, the MPU 31 performs processing for receiving the PES packet from the PES creating unit 13-1. In step S133, the MPU 31 performs processing for determining whether or not a PES packet is received. Upon determining that a PES packet is received (Yes in step S133), the MPU 31 advances the process to step S134. On the other hand, upon determining that no PES packet is received (No in step S133), the MPU 31 returns the process to step S132 in which it attempts the PES-packet reception processing again.

In step S134, on the basis of the data feed rate received in the processing in step S131 and the PES packet received in the processing in step S132, the MPU 31 performs processing for determining the amount of null TS packets to be created. In the processing in step S134, the MPU 31 first determines the amount of TS packets to be created by the TS creating unit 13-2, on the basis of the received PES packet, as described above. The MPU 31 then subtracts the determined amount of TS packets from the amount of transmission data corresponding to the received feed rate to thereby determine the amount of null TS packets to be created. In this processing, as described above, a table indicating relationships between the amount of data of the PES packet and the amount of TS packets to be created may be prepared so that the amount of TS packets to be created by the TS creating unit 13-2 can be determined based on the table.

In step S135, the MPU 31 performs processing for storing, in the TS payload in a TS packet, a bit string that does not contain the above-described predetermined bit string and that has repetitions of 0x55 (i.e., “01010101” in binary form). Subsequently, in step S136, the MPU 31 performs processing for creating a null TS packet by adding, to the TS payload, a predetermined TS header having a packet ID set to have a value indicating “null packet”.

Next, in step S137, the MPU 31 performs processing for determining whether or not the amount of null TS packets created in the processing in step S135 and S136 has reached the value of the amount determined in the processing in step S134. Upon determining that the amount of created null TS packets has reached the determined value (Yes in step S137), the MPU 31 finishes the null-TS packet creation and advances the process to step S138. On the other hand, upon determining that the amount of created null TS packets has not reached the determined value (No in step S137), the MPU 31 returns the process to step S135 and then performs the null-TS packet creation again in the processing in steps S135 and S136.

In step S138, the MPU 31 performs processing for obtaining the TS packet group created by the TS creating unit 13-2. Subsequently, in step S139, the MPU 31 performs processing for adding all null TS packets, created by repeating the processing in steps S135 and S136, to the end of the obtained TS packet group and outputting the resulting TS packets to the image feeding unit 14. Thereafter, upon completion of the processing in step S139, the MPU 31 returns the process to step S132 and re-executes the processing for receiving the PES packet from the PES creating unit 13-1 and the subsequent processing.

The above-described processing corresponds to the null-TS creation processing. Causing the MPU 31 to perform the null-TS creation processing allows the computer having the configuration in FIG. 14 to implement the null TS creating unit 13-3 in FIG. 11B. The null TS creating unit 13-3 does not generate a bit string to be subjected to the data insertion performed by the bit stuffing function. That is, the data output from the image encoding device 1 is data that satisfies the feed rate and that does not cause generation of a bit string to be subjected to the data insertion in the bit stuffing processing performed by the feeding-side modem 2. Thus, it is possible to adjust the transmission rate of the data string while suppressing an increase in the amount of transmission data, the increase being caused by the bit stuffing function.

The computer having the configuration in FIG. 14 can implement not only the null TS creating unit 13-3 but also some or all of the elements in the image encoding device 1. In order to achieve such a configuration, a control program for causing the MPU 31 to perform various types of processing performed by the functions provided by the elements in the image encoding device 1 is first created, as in the case in which the null TS creating unit 13-3 is implemented. The created control program may be pre-stored in the hard disk device 34 or on the portable recording medium 40 so that, thereafter, a predetermined instruction is given to the MPU 31 to cause it to read and execute the control program.

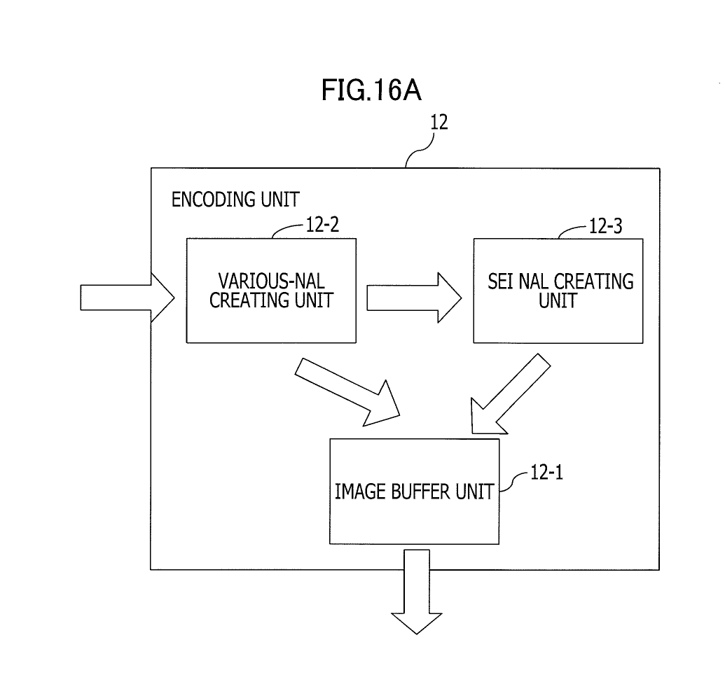

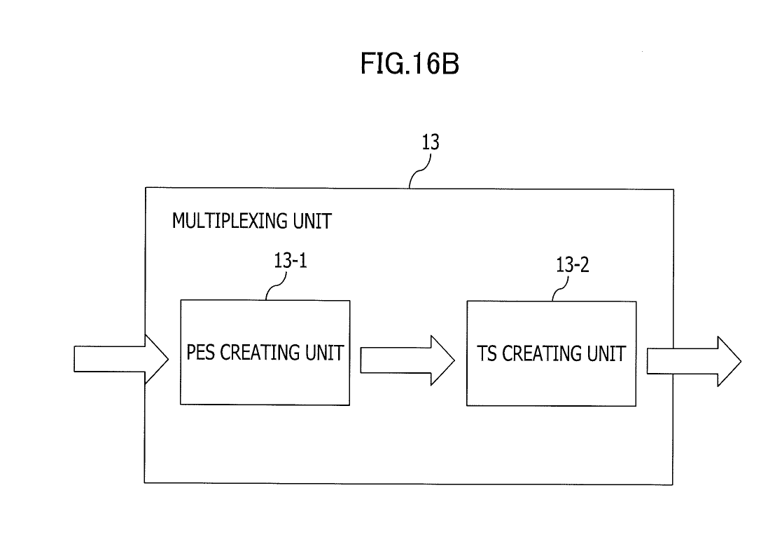

Next, a description will be given with reference to FIGS. 16A and 16B. FIGS. 16A and 16B illustrate second examples of the configurations of the encoding unit 12 and the multiplexing unit 13, respectively.

The encoding unit 12 illustrated in FIG. 16A includes a SEI (supplemental enhancement information) NAL creating unit 12-3 in addition to an image buffer unit 12-1 and a various-NAL creating unit 12-2 having configurations that are similar to the those in the first configuration example illustrated in FIG. 11A.

Since the image buffer unit 12-1 and the various-NAL creating unit 12-2 have the configurations that are similar to those in the first configuration example illustrated in FIG. 11A, descriptions thereof are not given hereinafter. In the second configuration example, the various-NAL creating unit 12-2 reports information regarding the amount of created image data to the SEI NAL creating unit 12-3.

The SEI NAL creating unit 12-3 creates a SEI (supplemental enhancement information) NAL unit (specified as nal_unit_type 6 in section 7.4.1 in the H.264 standard) that contains SEI. The SEI is information that is specified in section 7.4.2.3 in the H.264 standard and that is not essential for decoding encoding data. The SEI NAL creating unit 12-3 creates a SEI NAL so that SEI contained therein has a bit string that does not contain the above-described predetermined bit string. In particular, in the present embodiment, the SEI NAL created by the SEI NAL creating unit 12-3 contains a bit string that does not contain the above-described predetermined bit string and that is, for example, repetitions of 0x55, that is, “01010101” in binary form. In the present embodiment, the predetermined bit string is “11111” in binary form.

An example of the bit string is not limited to 0x55 and may be, for example, 0xAA, i.e., “10101010” in binary form. That is, the bit string may be any bit string that does not contain the bit string to be subjected to the bit stuffing processing. In the present embodiment, the bit string to be subjected to the bit stuffing processing is “11111” in binary form. With this arrangement, even when the bit stuffing unit 22 in the feeding-side modem 2 performs the bit stuffing processing, a “0” bit is not inserted into that bit string. This suppresses an increase in the amount of transmission data, the increase resulting from the bit stuffing.

Annex D.1 in the H.264 standard defines multiple types of data-containing structure (SEI payload syntax) for the SEI NAL. The SEI NAL creating unit 12-3 sets a payload type, which is contained in header information of a SEI NAL created and which indicates the data-containing structure for the SEI NAL, to a value indicating “user data unregistered”. In the H.264 standard, the value of the payload type indicating “user data unregistered” is defined to be “5”. According to the standard, any data can be contained in a SEI NAL having a payload type set to “user data unregistered”, and this SEI NAL is ignored during decoding of the encoded data. Thus, a SEI NAL containing a bit string, as described above, has almost no influence on image playback performed by the image-data receiving system 6.

The SEI NAL created by the SEI NAL creating unit 12-3 is output to the image buffer unit 12-1 in conjunction with a collection of various NAL units containing the image data created by the various-NAL creating unit 12-2, i.e., containing the encoded video data. Thus, the SEI NAL creating unit 12-3 outputs the created SEI NAL to the image buffer unit 12-1 between output of another NAL unit of the collection of the various NAL units created by the various-NAL creating unit 12-2 and output of the video NAL thereof.

The SEI NAL creating unit 12-3 also adjusts the amount of data of the SEI to be contained in the SEI NAL. This adjustment is performed so that the sum of the amount of data of a SEI NAL to be created and the amount of the above-described image data created by the various-NAL creating unit 12-2 corresponds to the feed rate of the image data string transmitted from the image-data feeding system 3 to the image-data receiving system 6. The above-described encoding bit rate that the control unit 15 reports to the encoding unit 12 is assumed to represent that feed rate. On the basis of the reported feed rate and the amount of image data created by the various-NAL creating unit 12-2, the SEI NAL creating unit 12-3 adjusts the amount of data of the SEI. As described above, the SEI NAL creating unit 12-3 adjusts the data feed rate for feeding the image data string from the image-data feeding system 3 to the image-data receiving system 6.

The configuration of the multiplexing unit 13 illustrated in FIG. 16B corresponds to a case in which the encoding unit 12 has the configuration illustrated in FIG. 16A. In the configuration illustrated in FIG. 16B, a PES creating unit 13-1 and a TS creating unit 13-2 having configurations that are similar to those in the first configuration example illustrated in FIG. 11B are provided, but the null TS creating unit 13-3 is eliminated.

Since the PES creating unit 13-1 and the TS creating unit 13-2 have the configurations that are similar to those in the first configuration example illustrated in FIG. 11B, descriptions thereof are not given hereinafter. The TS creating unit 13-2 outputs a created TS packet group to the image feeding unit 14.

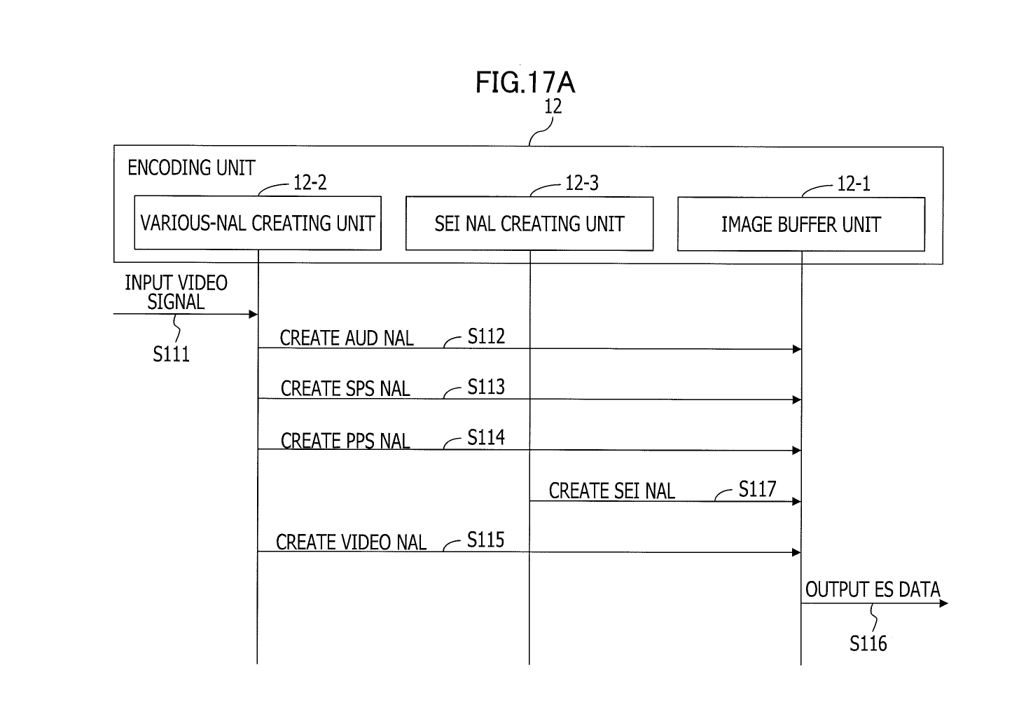

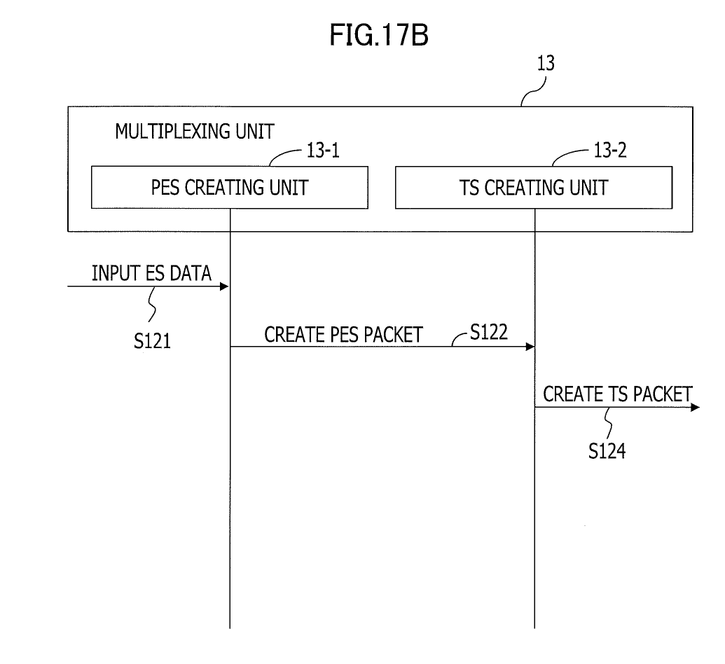

The operations of the encoding unit 12 having the configuration in FIG. 16A and the multiplexing unit 13 having the configuration in FIG. 16B will now be described with reference to FIGS. 17A and 17B. FIG. 17A illustrates a processing sequence for the elements in the encoding unit 12 having the configuration illustrated in FIG. 16A and FIG. 17B illustrates a processing sequence for the elements in the multiplexing unit 13 having the configuration illustrated in FIG. 16B.

In FIGS. 17A and 17B, operations of processing that are similar to those in the processing sequence in the first configuration examples of the encoding unit 12 illustrated in FIG. 12A and the multiplexing unit 13 illustrated in FIG. 12B are denoted by the same reference characters.

In step S103 described above and illustrated in FIG. 9, the received video signal is passed from the image input unit 11 to the encoding unit 12. In step S111 in FIG. 12A, the various-NAL creating unit 12-2 receives the input video signal and performs processing for creating various NAL units from the video signal and storing the NAL units in the image buffer unit 12-1. More specifically, in step S112, the various-NAL creating unit 12-2 performs processing for creating an AUD NAL and storing the AUD NAL in the image buffer unit 12-1. Next, in step S113, the various-NAL creating unit 12-2 performs processing for creating an SPS NAL and storing the SPS NAL in the image buffer unit 12-1. In step S114, the various-NAL creating unit 12-2 performs processing for creating a PPS NAL and storing the PPS NAL in the image buffer unit 12-1. Next, in step S115, the various-NAL creating unit 12-2 performs processing for creating a video NAL and storing the video NAL in the image buffer unit 12-1.

In FIG. 17A, however, in step S117, the SEI NAL creating unit 12-3 performs processing for creating the above-described SEI NAL and storing the SEI NAL in the image buffer unit 12-1, during a period of time from when the video NAL is created in the processing in step S115 until the video NAL is stored in the image buffer unit 12-1. In this case, the SEI NAL creating unit 12-3 determines the amount of data of the SEI NAL by subtracting the amount of created image data, the amount being reported from the various-NAL creating unit 12-2, from the amount of feed data corresponding to the aforementioned feed rate reported from the control unit 15. The amount of data of the SEI is determined by further subtracting the amount of data of the header information of the SEI NAL from the determined value of the amount of data of the SEI NAL.

In step S116, the various NAL units stored in the image buffer unit 12-1, as described above, are sequentially read by and output to the multiplexing unit 13 as ES data.

Next, in step S121 in FIG. 17B, the PES creating unit receives the ES data. In response, in step S122, the PES creating unit 13-1 performs processing for creating a PES packet from the ES data and outputting the PES packet to the TS creating unit 13-2.

Upon receiving the PES packet from the PES creating unit 13-1, in step S124, the TS creating unit 13-2 performs processing for creating a TS packet group containing the PES packet and outputting the TS packet group.

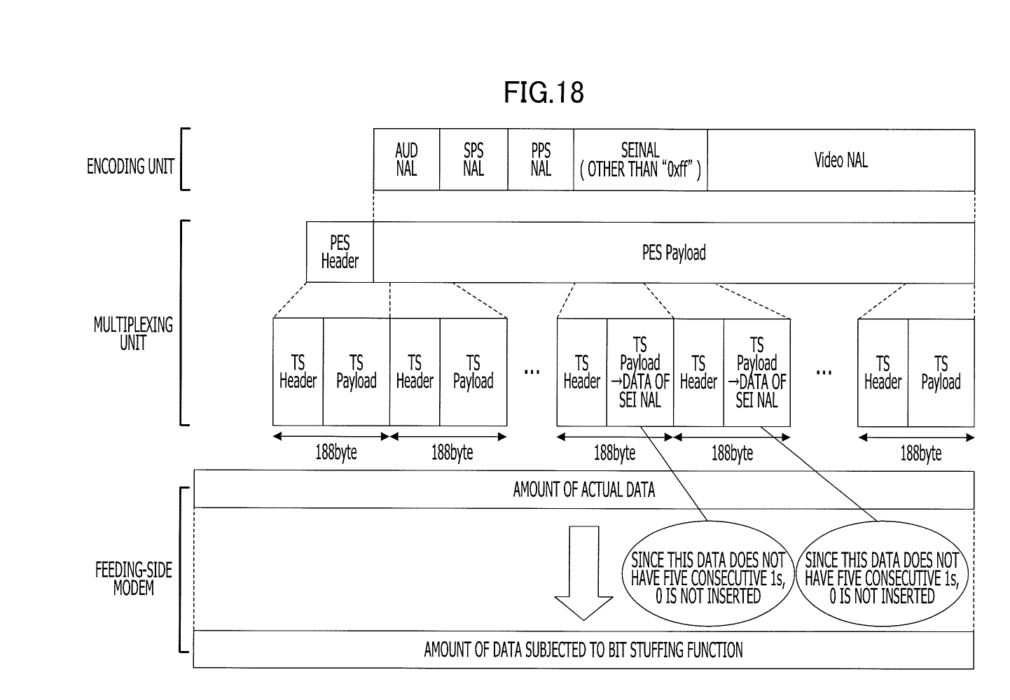

A description will now be given with reference to FIG. 18. FIG. 18 schematically illustrates a change in the amount of data of the data string output from the units in the image-data feeding system 3 having the image encoding device 1 when the encoding unit 12 and the multiplexing unit 13 have the respective configuration examples illustrated in FIG. 16A and FIG. 16B. An advantage of the data-feed-rate adjustment performed by the SEI NAL creating unit 12-3 will now be described with reference to FIG. 18 in comparison with FIG. 4.

As described above, in FIG. 4, in order to adjust the data feed rate, the above-described filler data is stored in the image buffer unit 12-1 in conjunction with the encoded data. Thus, the TS payload in each TS packet containing the above-mentioned filler-NAL-containing portion in the PES packet is filled with filler data having values of 0xff. Thus, the “0” bit insertion by the bit stuffing is performed a large number of times, and consequently, the amount of data transmitted from the modem increases significantly compared to the amount of data of the TS packets output from the multiplexing unit.

On the other hand, when the amount of data of the SEI NAL to be created by the SEI-NAL creating unit 12-3 is adjusted to adjust the data feed rate, the “0” bit insertion by the bit stuffing is not performed, since the predetermined bit string does not exist in the payload in the SEI NAL. Thus, as illustrated in FIG. 18, this arrangement suppresses an increase in the amount of data transmitted from the feeding-side modem 2 relative to the amount of data of the TS packets output from the multiplexing unit 13.

Causing a computer having a typical configuration as illustrated in FIG. 14 to execute a predetermined control program also allows the computer to implement the SEI NAL creating unit 12-3 in FIG. 16A. In such a case, a control program for causing the MPU 31 to perform SEI NAL creation processing described below is created first. The created control program is pre-stored in the hard disk device 34 or on the portable recording medium 40. A predetermined instruction is then given to the MPU 31 to cause it to read and execute the control program. With this arrangement, the MPU 31 in the computer illustrated in FIG. 14 serves as the SEI NAL creating unit 12-3.

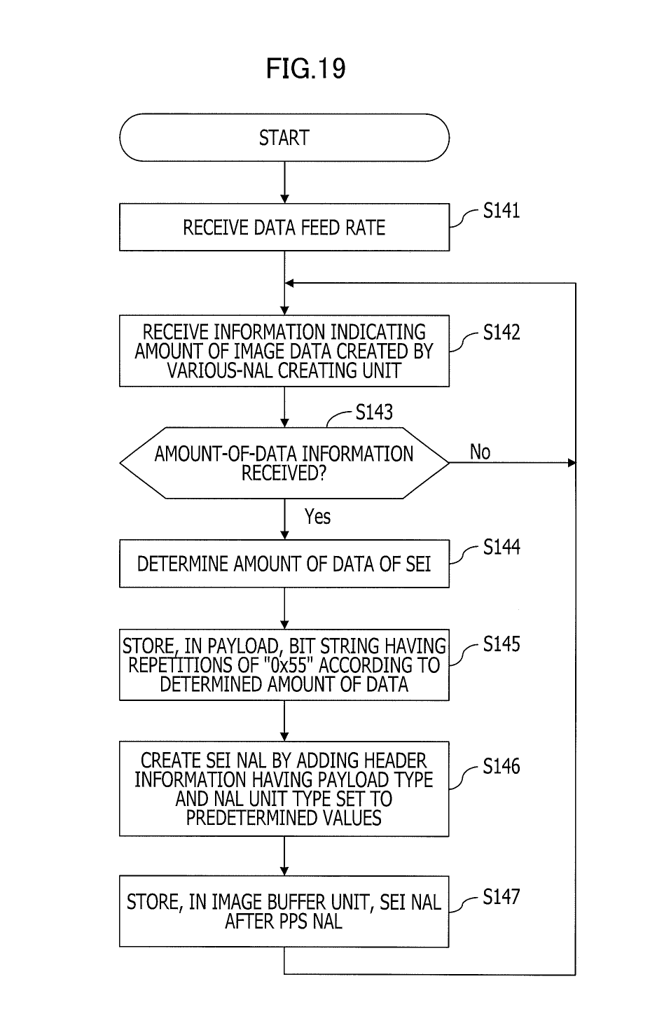

A description will now be given with reference to FIG. 19. FIG. 19 is a flowchart illustrating the operations of the SEI NAL creation processing that is to be performed by the MPU 31 so as to cause the computer to serve as the SEI NAL creating unit 12-3.

Upon start of the processing in FIG. 19, first, in step S141, the MPU 31 performs processing for receiving the encoding bit rate, i.e., the aforementioned feed rate, reported from the control unit 15.

Next, in step S142, the MPU 31 performs processing for receiving information indicating the amount of image data created by the various-NAL creating unit 12-2, the information being reported from the various-NAL creating unit 12-2. Subsequently, in step S143, the MPU 31 performs processing for determining whether or not the amount-of-created-image data information is received. Upon determining that the amount-of-created-image-data information is received (Yes in step S143), the MPU 31 advances the process to step S144. On the other hand, upon determining that the amount-of-created-image-data information is not received (No in step S143), the MPU 31 returns the process to step S142 in which it attempts the reception processing of the amount-of-created-image-data information again.

In step S144, on the basis of the data feed rate received in the processing in step S141 and the amount-of-created-image-data information received in the processing in step S142, the MPU 31 performs processing for determining a value of the amount of SEI to be contained in a SEI NAL created. In this processing, the MPU 31 determines the amount of data of the SEI by performing processing for subtracting the received amount-of-created-image-data information from the amount of feed data corresponding to the received feed rate and further subtracting the amount of data of the header information of the SEI NAL from the result of the subtraction.

In step S145, the MPU 31 performs processing for storing, in the payload in the SEI NAL, a bit string that does not contain the above-described predetermined bit string and that has repetitions of 0x55 (i.e., “01010101” in binary form). Subsequently, in step S146, the MPU 31 performs processing for creating a SEI NAL by adding predetermined header information to the payload. With respect to the header information, the payload type and the NAL unit type are preset to values indicating “user data unregistered” and “SEI NAL”, respectively.

Next, in step S147, the MPU 31 performs processing for storing, in the image buffer unit 12-1, the SEI NAL created in the processing in steps S145 and S146 so that the SEI NAL follows the PPS NAL created by the various-NAL creating unit 12-2, i.e., so that the SEI NAL precedes the video NAL. Upon completion of the processing in step S147, the MPU 31 returns the process to step S142 and re-executes the processing for receiving the information regarding the amount of image data created by the various-NAL creating unit 12-2 and the subsequent processing.

The SEI NAL creating unit 12-3 does not generate a bit string to be subjected to the data insertion performed by the bit stuffing function. That is, the data output from the image encoding device 1 is data that satisfies the feed rate and that does not cause generation of a bit string to be subjected to the data insertion in the bit stuffing processing performed by the feeding-side modem 2. Thus, it is possible to adjust the transmission rate of the data string while suppressing an increase in the amount of transmission data, the increase being caused by the bit stuffing function.

The above-described processing corresponds to the SEI NAL creation processing. Causing the MPU 31 to perform the SEI NAL creation processing allows the computer having the configuration in FIG. 14 to implement the SEI NAL creating unit 12-3 in FIG. 16A.

The computer having the configuration in FIG. 14 can implement not only the SEI NAL creating unit 12-3 but also some or all of the elements in the image encoding device 1, as described above.

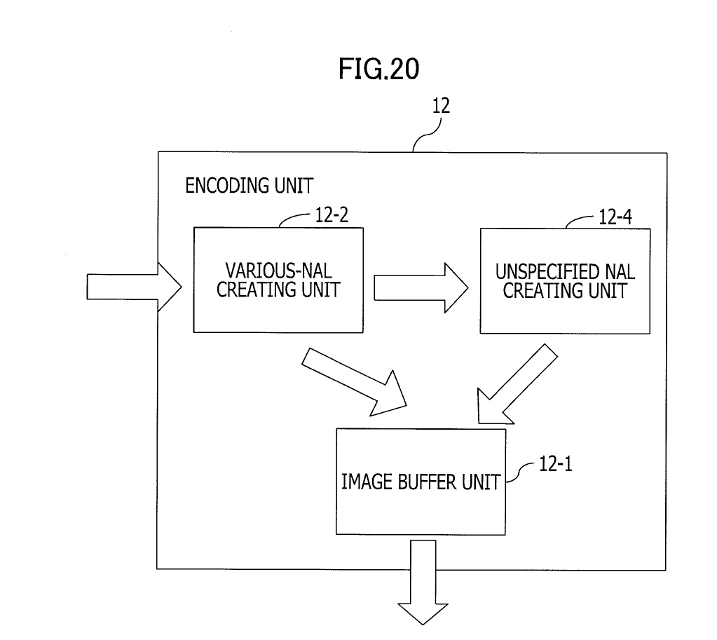

Configuration of the encoding unit 12, as illustrated in FIG. 20, rather than the configuration illustrated in FIG. 16A also makes it possible to adjust the data feed rate for feeding the video data string. A third example of the configuration of the encoding unit 12 will now be described with reference to FIG. 20.

The encoding unit 12 illustrated in FIG. 20 has a configuration in which the SEI NAL creating unit 12-3 in the second configuration example in FIG. 16A is replaced with an unspecified-NAL creating unit 12-4.

Since an image buffer unit 12-1 and a various-NAL creating unit 12-2 have the configurations that are similar to those in the first configuration example illustrated in FIG. 11A, descriptions thereof are not given hereinafter. In the third configuration example, the various-NAL creating unit 12-2 reports information regarding the amount of created image data to the unspecified-NAL creating unit 12-4.

The unspecified-NAL creating unit 12-4 creates a NAL unit that contains data whose contents are unspecified, i.e., contains a type of NAL unit specified as nal_unit_type 0, or 24-31, in section 7.4.1 in the H.264 standard. This NAL unit will hereinafter be referred to as an “unspecified NAL”.

The unspecified NAL created by the unspecified-NAL creating unit 12-4 contains a data string that does not contain the above-described predetermined bit string. In particular, in the present embodiment, the unspecified NAL created by the unspecified-NAL creating unit 12-4 contains a bit string that does not contain the above-described predetermined bit string and that is, for example, repetitions of 0x55, that is, “01010101” in binary form. In the present embodiment, the predetermined bit string is “11111” in binary form.

An example of the bit string is not limited to 0x55 and may be, for example, 0xAA, i.e., “10101010” in binary form. That is, the bit string may be any bit string that does not contain the bit string to be subjected to the bit stuffing processing. In the present embodiment, the bit string to be subjected to the bit stuffing processing is “11111” in binary form. With this arrangement, even when the bit stuffing unit 22 in the feeding-side modem 2 performs the bit stuffing processing, a “0” bit is not inserted into that bit string. This suppresses an increase in the amount of transmission data, the increase resulting from the bit stuffing.

The unspecified NAL created by the unspecified-NAL creating unit 12-4 is output to the image buffer unit 12-1 in conjunction with a collection of various NAL units containing the image data created by the various-NAL creating unit 12-2, i.e., containing the encoded video data. Thus, the unspecified-NAL creating unit 12-4 outputs the created unspecified NAL to the image buffer unit 12-1 so that the unspecified NAL follows the output of the collection of the various NAL units created by the various-NAL creating unit 12-2.

The unspecified-NAL creating unit 12-4 also adjusts the amount of data of the bit string to be contained in the unspecified NAL. This adjustment is performed so that the sum of the amount of data of an unspecified NAL to be created and the amount of the above-described image data created by the various-NAL creating unit 12-2 corresponds to the feed rate of the image data string transmitted from the image-data feeding system 3 to the image-data receiving system 6. The above-described encoding bit rate that the control unit 15 reports to the encoding unit 12 is assumed to represent that feed rate. On the basis of the reported feed rate and the amount of image data created by the various-NAL creating unit 12-2, the unspecified-NAL creating unit 12-4 adjusts the amount of data of the bit string. As described above, the unspecified-NAL creating unit 12-4 adjusts the data feed rate for feeding the image data string from the image-data feeding system 3 to the image-data receiving system 6.

The configuration of the multiplexing unit 13 when the encoding unit 12 has the configuration illustrated in FIG. 20 may be the same as the second configuration example illustrated in FIG. 16B.

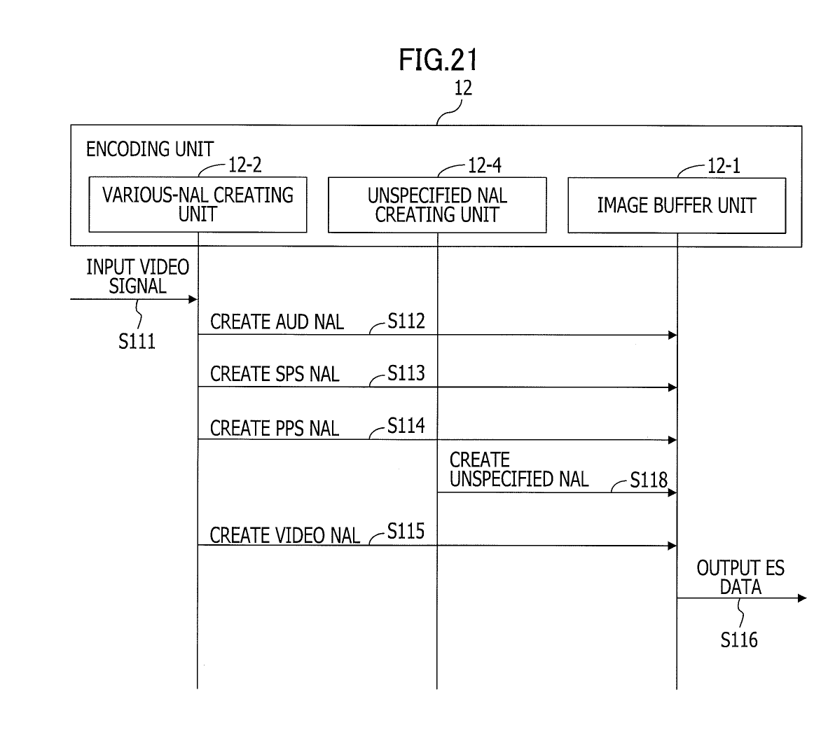

The operation of the encoding unit 12 having the configuration illustrated in FIG. 20 will now be described with reference to FIG. 21. FIG. 21 illustrates a processing sequence for the elements in the encoding unit 12 having the configuration in FIG. 20.

In FIG. 21, operations of processing that are similar to those in the processing sequence in the first configuration example of the encoding unit 12 illustrated in FIG. 12A and the second configuration example of the encoding unit 12 illustrated in 17A are denoted by the same reference characters.

First, in step S103 described above and illustrated in FIG. 9, the received video signal is passed from the image input unit 11 to the encoding unit 12. In step S111 in FIG. 21, the various-NAL creating unit 12-2 receives the input video signal and then performs processing for creating various NAL units from the video signal and storing the NAL units in the image buffer unit 12-1. More specifically, in step S112, the various-NAL creating unit 12-2 performs processing for creating an AUD NAL and storing the AUD NAL in the image buffer unit 12-1. Next, in step S113, the various-NAL creating unit 12-2 performs processing for creating an SPS NAL and storing the SPS NAL in the image buffer unit 12-1. In step S114, the various-NAL creating unit 12-2 performs processing for creating a PPS NAL and storing the PPS NAL in the image buffer unit 12-1. In step S115, the various-NAL creating unit 12-2 performs processing for creating a video NAL and storing the video NAL in the image buffer unit 12-1.

In FIG. 21, in step S118, the unspecified-NAL creating unit 12-4 performs processing for creating the above-described unspecified NAL and storing the unspecified NAL in the image buffer unit 12-1. In this case, the unspecified-NAL creating unit 12-4 determines the amount of data of the unspecified NAL by subtracting the amount of created image data, the amount being reported from the various-NAL creating unit 12-2, from the amount of feed data corresponding to the aforementioned feed rate reported from the control unit 15. The amount of data of a bit string to be contained in the unspecified NAL is determined by further subtracting the amount of data of the header information of the unspecified NAL from the determined value of the amount of data of the unspecified NAL.

In step S116, the various NAL units stored in the image buffer unit 12-1, as described above, are sequentially read by and output to the multiplexing unit 13 as ES data.

A processing sequence performed by the multiplexing unit 13 after the processing in step S116 is the same as the processing sequence illustrated in FIG. 17B, and thus, a description thereof is not given hereinafter.

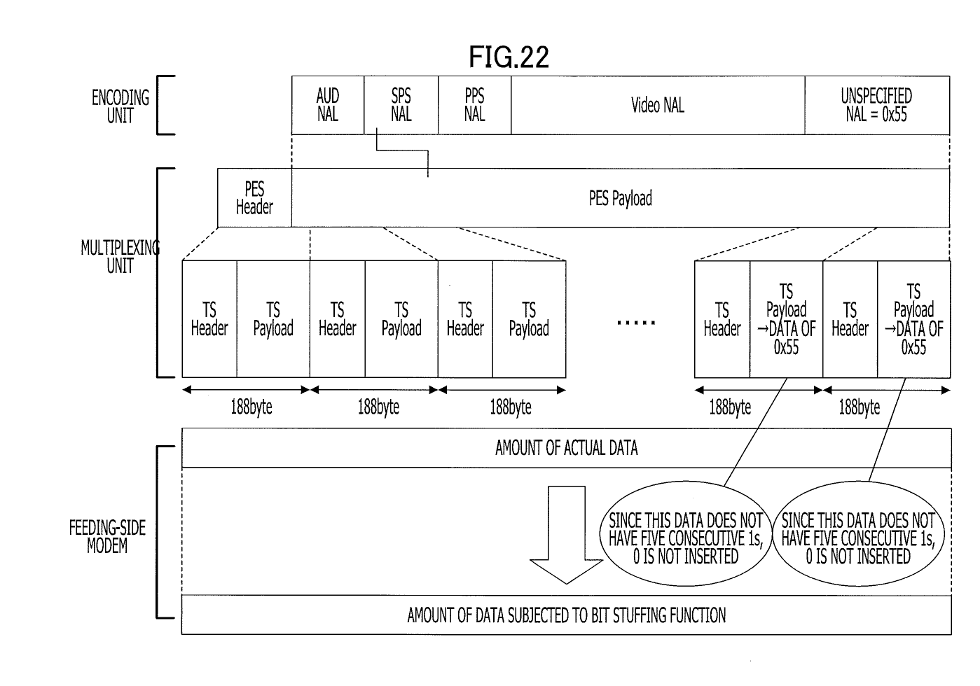

A description will now be given with reference to FIG. 22. FIG. 22 schematically illustrates a change in the amount of data of the data string output from the units in the image-data feeding system 3 having the image encoding device 1 when the encoding unit 12 and the multiplexing unit 13 have the respective configuration examples illustrated in FIG. 20 and FIG. 16B. An advantage of the data-feed-rate adjustment performed by the unspecified-NAL creating unit 12-4 will now be described with reference to FIG. 18 in comparison with FIG. 4.

As described above, in FIG. 4, in order to adjust the data feed rate, the above-described filler data is stored in the image buffer unit 12-1 in conjunction with the encoded data. Thus, the TS payload in the TS packet containing the above-mentioned filler-NAL-containing portion in the PES packet is filled with filler data having values of 0xff. Thus, the “0” bit insertion by the bit stuffing is performed a large number of times, and thus the amount of data transmitted from the modem increases significantly compared to the amount of data of the TS packets output from the multiplexing unit.

On the other hand, when the amount of data of the unspecified NAL to be created by the unspecified-NAL creating unit 12-4 is adjusted to adjust the data feed rate, the “0” bit insertion by the bit stuffing is not performed, since the predetermined bit string does not exist in the payload in the unspecified NAL. Thus, as illustrated in FIG. 18, this arrangement suppresses an increase in the amount of data transmitted from the feeding-side modem 2 relative to the amount of data of the TS packets output from the multiplexing unit 13.

Causing a computer having a typical configuration as illustrated in FIG. 14 to execute a predetermined control program also allows the computer to implement the unspecified-NAL creating unit 12-4 in FIG. 20. In such a case, a control program for causing the MPU 31 to perform unspecified-NAL creation processing described below is created first. The created control program is pre-stored in the hard disk device 34 or on the portable recording medium 40. A predetermined instruction is then given to the MPU 31 to cause it to read and execute the control program. With this arrangement, the MPU 31 in the computer illustrated in FIG. 14 serves as the unspecified-NAL creating unit 12-4.

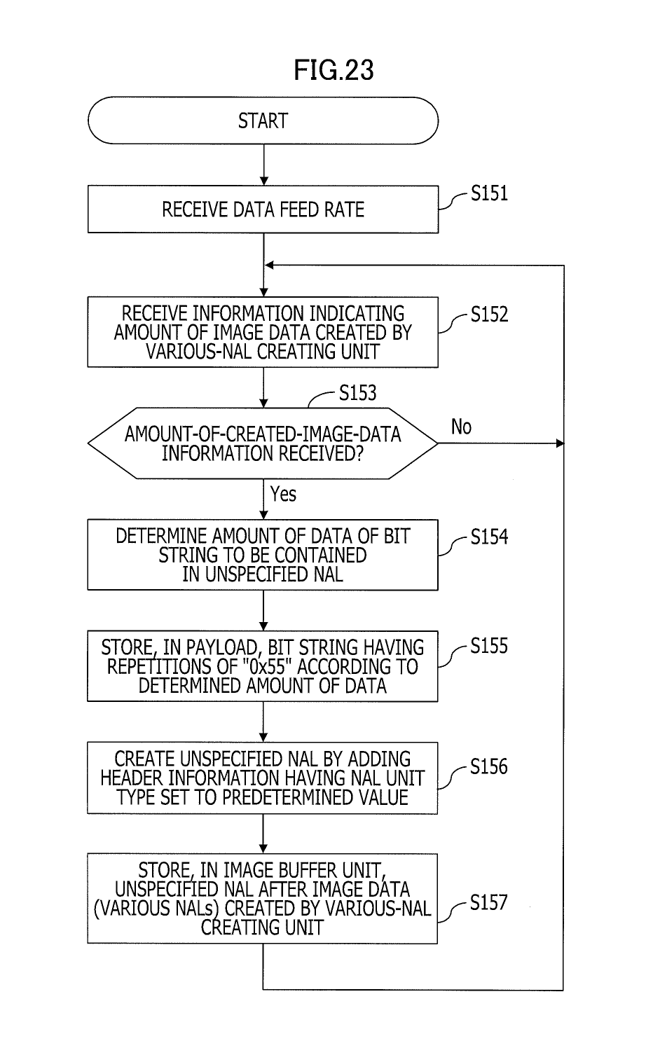

A description will now be given with reference to FIG. 23. FIG. 23 is a flowchart illustrating operations of the unspecified-NAL creation processing that is to be performed by the MPU 31 so as to cause the computer to serve as the unspecified-NAL creating unit 12-4.

Upon start of the processing in FIG. 23, first, in step S151, the MPU 31 performs processing for receiving the encoding bit rate, i.e., the aforementioned data feed rate, reported from the control unit 15.

Next, in step S152, the MPU 31 performs processing for receiving information regarding the amount of image data created by the various-NAL creating unit 12-2, the information being reported from the various-NAL creating unit 12-2. Subsequently, in step S153, the MPU 31 performs processing for determining whether or not the amount-of-created-image data information is received. Upon determining that the amount-of-created-image-data information is received (Yes in step S153), the MPU 31 advances the process to step S154. On the other hand, upon determining that the amount-of-created-image-data information is not received (No in step S153), the MPU 31 returns the process to step S152 in which it attempts the reception processing of the amount-of-created-image-data information again.

In step S154, on the basis of the data feed rate received in the processing in step S151 and the amount-of-created-image-data information received in the processing in step S152, the MPU 31 performs processing for determining a value of the amount of data of a bit string to be contained in an unspecified NAL created. In this processing, the MPU 31 determines the amount of data of the bit string by performing processing for subtracting the received amount-of-created-image-data information from the amount of feed data corresponding to the received feed rate and further subtracting the amount of data of the header information of the unspecified NAL from the result of the subtraction.

In step S155, the MPU 31 performs processing for storing, in the payload in the unspecified NAL, a bit string that does not contain the above-described predetermined bit string and that has repetitions of 0x55 (i.e., “01010101” in binary form). Subsequently, in step S156, the MPU 31 performs processing for creating an unspecified NAL by adding predetermined header information to the payload. The NAL unit type in the header information is set to a value indicating “unspecified”.

Next, in step S157, the MPU 31 performs processing for storing, in the image buffer unit 12-1, the unspecified NAL created in the processing in steps S155 and S156 so that the unspecified NAL follows the collection of the NAL units containing the image data, i.e., the encoded data, created by the various-NAL creating unit 12-2. Thereafter, upon completion of the processing in step S157, the MPU 31 returns the process to step S152 and re-executes the processing for receiving the information regarding the amount of image data created by the various-NAL creating unit 12-2 and the subsequent processing.

The unspecified-NAL creating unit 12-4 does not generate a bit string to be subjected to the data insertion performed by the bit stuffing function. That is, the data output from the image encoding device 1 is data that satisfies the feed rate and that does not cause generation of a bit string to be subjected to the data insertion in the bit stuffing processing performed by the feeding-side modem 2. Thus, it is possible to adjust the transmission rate of the data string while suppressing an increase in the amount of transmission data, the increase being caused by the bit stuffing function.

The above-described processing corresponds to the unspecified-NAL creation processing. Causing the MPU 31 to perform the unspecified-NAL creation processing allows the computer having the configuration in FIG. 14 to implement the unspecified-NAL creating unit 12-4 in FIG. 20.

The computer having the configuration in FIG. 14 can implement not only the unspecified-NAL creating unit 12-4 but also some or all of the elements in the image encoding device 1, as described above.

The present invention is not limited to the above-described embodiments, and in practice, various changes and modifications can be made thereto without departing from the spirit and scope of the present invention.

For example, the description in the above-described embodiments has been given of the image encoding device 1 for adjusting the data feed rate for feeding an image data string obtained by the video encoding specified by the H.264 standard. The present invention is also applicable to adjustment of a data feed rate for feeding an image data string obtained by another video encoding system. In addition, the present invention is applicable to adjustment of a data feed rate for transmitting a data string other than an image data string.

The description in the above embodiments has been given of the image encoding device 1 that suppresses an increase in the amount of transmission data, the increase being caused by the bit stuffing, during data transfer in the PPP-connection-based HDLC procedures. The present invention is also applicable to suppression of an increase in the amount of transmission data, the increase being caused by bit stuffing performed by various types of transmission system, such as USB system, for transmitting a digital data string.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above may be non-transitory media.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. A data-rate adjusting device, comprising:
a first processing unit that adjusts a data rate for outputting an input data string by adding a bit string to the data string, the bit string being different from a predetermined bit string having a predetermined number of consecutive bits of an identical value; and
a second processing unit that outputs, to a data transmitting device, the data string to which the bit string is added.

2. The data-rate adjusting device according to claim 1, wherein the predetermined data string comprises flag data added to the data string transmitted by a transmitting unit in the data transmitting device and used for data string transmission in flag synchronization control.

3. The data-rate adjusting device according to claim 1, wherein the data string is a transport stream specified for a data multiplexing system by an MPEG-2 system standard, and
the first processing unit adjusts the data rate by adding a transport stream packet having a payload containing the bit string to the transport stream.

4. The data-rate adjusting device according to claim 3, wherein the first processing unit sets a packet identifier to a value indicating a null packet, the packet identifier being contained in header information of the transport stream packet and being indicative of a type of data stored in the payload in the transport stream packet.

5. The data-rate adjusting device according to claim 1, wherein the data string is a collection of network-abstraction-layers containing encoded video data, the network-abstraction-layers being specified by an H.264 standard, and
the first processing unit adjusts the data rate by adding a network-abstraction-layer unit containing the bit string to a collection of the network-abstraction-layer units that are the data strings.

6. The data-rate adjusting device according to claim 5, wherein the first processing unit adjusts the data rate by adding, to a collection of network-abstraction-layer units that are the data stings, a supplemental-enhancement-information-network-abstraction-layer that is one type of network-abstraction-layer unit specified by the H.264 standard, the supplemental-enhancement-information-network abstraction-layer containing the bit string.

7. The data-rate adjusting device according to claim 6, wherein the first processing unit sets a payload type to a value indicating user data as unregistered, the payload type being contained in header information of the supplemental-enhancement-information-network-abstraction-layer and being indicative of a data-containing structure of the supplemental-enhancement-information-network-abstraction-layer.

8. The data-rate adjusting device according to claim 5, wherein the first processing unit adjusts the data rate by adding a payload in a network-abstraction-layer unit defined by the H.264 standard as being unspecified, the payload containing the bit string, to a collection of network-abstraction-layer units that are the data strings.

9. A non-transitory computer-readable medium for recording a program allowing a computer to execute the steps of:
obtaining a data string;
creating a bit string, that is different from a predetermined bit string having a predetermined number of consecutive bits of an identical value;
adjusting a data rate for outputting the data string by adding the created bit string to the obtained data string; and
outputting the data string having the adjusted data rate to a data transmitting device.

10. The computer-readable medium according to claim 9, wherein the predetermined bit string comprises flag data to be added to a data string output by the data transmitting device and to be used for data string transmission in flag synchronization control.

11. The computer-readable medium according to claim 9, wherein the data string is a transport stream specified for a data multiplexing system by an MPEG-2 system standard, and
in the adjustment, the data rate is adjusted by adding, to the transport stream, a transport stream packet having a payload that contains a bit string that does not include the predetermined bit string.

12. The computer-readable medium according to claim 11, wherein in the adjustment, a packet identifier that is contained in header information of the transport stream packet and that is indicative of a type of data stored in the payload in the transport stream packet is set to a value indicating a null packet.

13. The computer-readable medium according to claim 9, wherein the data string is a collection of network-abstraction-layers containing encoded video data, the network-abstraction-layers being specified by an H.264 standard, and
in the adjustment, the data rate is adjusted by adding, to a collection of the network-abstraction-layer units that are the data strings, a network-abstraction-layer unit containing a bit string that does not include the predetermined bit string.

14. The computer-readable medium according to claim 13, wherein in the adjustment, the data rate is adjusted by adding, to a collection of network-abstraction-layer units that are the data stings, a supplemental-enhancement-information-network-abstraction-layer that is one type of network-abstraction-layer unit specified by the H.264 standard, the supplemental-enhancement-information-network-abstraction-layer containing a bit string that does not include the predetermined bit string.

15. The computer-readable medium according to claim 14, wherein in the adjustment, a payload type is set to a value indicating user data as unregistered, the payload type being contained in header information of the supplemental-enhancement-information-network-abstraction-layer and being indicative of a data-containing structure of the supplemental-enhancement-information-network-abstraction-layer.

16. The computer-readable medium according to claim 13, wherein in the adjustment, the data rate is adjusted by adding, to a collection of network-abstraction-layer units that are the data strings, payload in a type of network-abstraction-layer unit defined by the H.264 standard as being unspecified, the payload containing a bit string that does not include the predetermined bit string.

17. A data feeding system, comprising:
a data transmitting device including:
a transmitting unit that transmits an input data string, and
a bit stuffing unit that inserts, when the data string to be transmitted by the transmitting unit contains a predetermined bit string having a predetermined number of consecutive bits of an identical value, a bit next to the predetermined bit string in the data string, the bit having a different value from the identical value; and
a data-rate adjusting device including:
a first processing unit that adjusts a data rate for outputting the data string input to the data transmitting device, by adding a bit string that is different from the predetermined bit string to the data string, and
a second processing unit that outputs, to the data transmitting device, the data string to which the bit string is added.
